(19) United States
(12) Patent Application Publication
(10) Pub. No.: US 2016/0170228 A1
(43) Pub. Date: Jun. 16, 2016

(54) VARIABLE FOCAL LENGTH LENS, OPTICAL APPARATUS, AND ADJUSTMENT METHOD FOR VARIABLE FOCAL LENGTH LENS

(71) Applicant: Nikon Corporation, Tokyo (JP)

(72) Inventor: Akira YAMAGAMI, Kawasaki-shi (JP)

(21) Appl. No.: 15/049,038

(22) Filed: Feb. 20, 2016

Related U.S. Application Data
(63) Continuation of application No. PCT/JP2014/071611, filed on Aug. 19, 2014.

(30) Foreign Application Priority Data
Aug. 20, 2013 (JP) 2013-170493

(51) Int. Cl. G02B 27/64; G02B 15/15; G02B 7/10; G02B 9/64; G02B 27/00

(52) U.S. Cl. CPC G02B 27/646; G02B 9/64; G02B 27/0025; G02B 7/10; G02B 15/15

(57) ABSTRACT

Provided are a variable focal length imaging lens, an optical apparatus having the imaging lens and a method for adjusting the imaging lens, whereby it is possible to achieve satisfactory optical performance and reduce a cost. The imaging lens comprises, in order from an object side, a first lens group G1 having negative refractive power and a second lens group G2 having positive refractive power. A focal length of the imaging lens is varied by changing an air space between the first lens group and the second lens group. The imaging lens further comprises an adjustment mechanism 20, 30 which performs a position adjustment for making shift decentering or tilt decentering of a whole or a partial lens group of the first lens group and a partial lens group of the second lens group, after assembling the first lens group and the second lens group.

### TECHNICAL FIELD

The present invention relates to a variable focal length lens, an optical apparatus equipped with the variable focal length lens, and an adjustment method for the variable focal length lens.

### BACKGROUND ART

There has been proposed various variable focal length lenses suitable for a photographing camera, an electronic still camera, a video camera or the like. For example, see Japanese Patent Laid-open Publication No. 2009-48012.

### PRIOR ART DOCUMENT

### Patent Document

Patent Document 1: Japanese Patent Laid-open Publication No. 2009-48012

### SUMMARY OF INVENTION

### Technical Problem

In the conventional variable focal length lens, there has been found a problem that when a decentering error occurs, an imaging performance is decreased. Incidentally, for prevention from deterioration of the imaging performance, it is required to improve a shape accuracy of lenses, lens chambers and mechanical elements and thereby reduce the decentering error. However, this demands a higher machining accuracy, so that it is hard to realize reduction of a cost. Furthermore, when a zoom ratio of the variable focal length lens is large, deterioration of the imaging performance becomes more serious, so that a still higher machining accuracy is required. In particular, it is very hard to prevent deterioration of the imaging performance in the entire area of the variable focal length from a wide angle end state to a telephoto end state.

The present invention is made in view of the above-described problem, and has an object to provide a variable focal length lens capable of reducing a cost and achieving a satisfactory optical performance, an optical apparatus equipped with the variable focal length lens, and an adjustment method for the variable focal length lens.

### Solution to Problem

In order to solve the above-mentioned problems, the present invention provides

a variable focal length lens comprising, in order from an object side, a first lens group having negative refractive power and a second lens group having positive refractive power,

a focal length being varied by changing an air space between the first lens group and the second lens group, and

the adjustment mechanism being provided, the adjustment mechanism performing a position adjustment for making shift decentering or tilt decentering of a whole or a partial lens group of the first lens group and a partial lens group of the second lens group, after assembling the first lens group and the second lens group.

Further, the present invention provides an optical apparatus equipped with the variable focal length lens.

Further, the present invention provides

a method for adjusting a variable focal length lens which comprises, in order from an object side, a first lens group having negative refractive power and a second lens group having positive refractive power,

a focal length being varied by changing an air space between the first lens group and the second lens group,

the adjustment in the method being performed by the adjustment mechanism for performing a position adjustment for making shift decentering or tilt decentering of a whole or a partial lens group of the first lens group and a partial lens group of the second lens group, after assembling the first lens group and the second lens group.

### Advantageous Effects of Invention

According to the present invention, a variable focal length lens capable of reducing a cost and achieving a satisfactory optical performance, an optical apparatus equipped with the variable focal length lens, and an adjustment method for the variable focal length lens can be provided.

### BRIEF DESCRIPTION OF DRAWINGS

FIG. 1 is a sectional view showing a configuration of a variable focal length lens relating to first to tenth Examples.

FIGS. 2A, 2B and 2C show diagrams of coma aberrations for d-line (wavelength λ=587.6 nm) in an infinite focusing state of the variable focal length lens relating to the first to tenth Examples in case of no occurrence of decentering error in the manufacture, and FIGS. 2A, 2B and 2C indicate a wide angle end state, an intermediate focal length state, and a telephoto end state, respectively.

FIGS. 3A, 3B and 3C show diagrams of coma aberrations for d-line (wavelength λ=587.6 nm) in the infinite focusing state of the variable focal length lens relating to the first to tenth Examples in case of occurrence of decentering error in the manufacture, and FIGS. 3A, 3B and 3C indicate the wide angle end state, the intermediate focal length state, and the telephoto end state, respectively.

FIG. 4 is a sectional view showing a mechanism of the variable focal length lens relating to the first Example.

FIG. 5 is a sectional view showing a first adjustment mechanism for decentering a lens to an optical axis in the Examples of the present application.

FIG. 6 is a sectional view showing a second adjustment mechanism for decentering a lens to the optical axis in the Examples of the present application.

FIGS. 7A, 7B and 7C show diagrams of coma aberrations for d-line (wavelength λ=587.6 nm) in the infinite focusing state of the variable focal length lens relating to the first Example after adjustment of decentering error having occurred in the manufacture by means of the first and second adjustment mechanisms, and FIGS. 7A, 7B and 7C indicate the wide angle end state, the intermediate focal length state, and the telephoto end state, respectively.

FIG. 8 is a sectional view showing a mechanism of the variable focal length lens relating to the second Example.

FIGS. 9A, 9B and 9C show diagrams of coma aberrations for d-line (wavelength λ=587.6 nm) in the infinite focusing state of the variable focal length lens relating to the second Example after adjustment of decentering error having occurred in the manufacture by means of the first and second adjustment mechanisms, and FIGS. 9A, 9B and 9C indicate the wide angle end state, the intermediate focal length state, and the telephoto end state, respectively.

FIG. 10 is a sectional view showing a mechanism of the variable focal length lens relating to the third Example.

FIG. 11 is a sectional view showing a third adjustment mechanism for decentering a lens to the optical axis in the Examples of the present application.

FIGS. 12A, 12B and 12C show diagrams of coma aberrations for d-line (wavelength λ=587.6 nm) in the infinite focusing state of the variable focal length lens relating to the third Example after adjustment of decentering error having occurred in the manufacture by means of the first and third adjustment mechanisms, and FIGS. 12A, 12B and 12C indicate the wide angle end state, the intermediate focal length state, and the telephoto end state, respectively.

FIG. 13 is a sectional view showing a mechanism of the variable focal length lens relating to the fourth Example.

FIG. 14 is a sectional view showing a fourth adjustment mechanism for decentering a lens to the optical axis in the Examples of the present application.

FIGS. 15A, 15B and 15C show diagrams of coma aberrations for d-line (wavelength λ=587.6 nm) in the infinite focusing state of the variable focal length lens relating to the fourth Example after adjustment of decentering error having occurred in the manufacture by means of the first and fourth adjustment mechanisms, and FIGS. 15A, 15B and 15C indicate the wide angle end state, the intermediate focal length state, and the telephoto end state, respectively.

FIG. 16 is a sectional view showing a mechanism of the variable focal length lens relating to the fifth Example.

FIGS. 17A, 17B and 17C show diagrams of coma aberrations for d-line (wavelength λ=587.6 nm) in the infinite focusing state of the variable focal length lens relating to the fifth Example after adjustment of decentering error having occurred in the manufacture by means of the third adjustment mechanism, and FIGS. 17A, 17B and 17C indicate the wide angle end state, the intermediate focal length state, and the telephoto end state, respectively.

FIG. 18 is a sectional view showing a mechanism of the variable focal length lens relating to the sixth Example.

FIGS. 19A, 19B and 19C show diagrams of coma aberrations for d-line (wavelength λ=587.6 nm) in the infinite focusing state of the variable focal length lens relating to the sixth Example after adjustment of decentering error having occurred in the manufacture by means of the third and fourth adjustment mechanisms, and FIGS. 19A, 19B and 19C indicate the wide angle end state, the intermediate focal length state, and the telephoto end state, respectively.

FIG. 20 is a sectional view showing a mechanism of the variable focal length lens relating to the seventh Example.

FIGS. 21A, 21B and 21C show diagrams of coma aberrations for d-line (wavelength λ=587.6 nm) in the infinite focusing state of the variable focal length lens relating to the seventh Example after adjustment of decentering error having occurred in the manufacture by means of the second adjustment mechanism, and FIGS. 21A, 21B and 21C indicate the wide angle end state, the intermediate focal length state, and the telephoto end state, respectively.

FIG. 22 is a sectional view showing a mechanism of the variable focal length lens relating to the eighth Example.

FIGS. 23A, 23B and 23C show diagrams of coma aberrations for d-line (wavelength λ=587.6 nm) in the infinite focusing state of the variable focal length lens relating to the eighth Example after adjustment of decentering error having occurred in the manufacture by means of the third adjustment mechanism, and FIGS. 23A, 23B and 23C indicate the wide angle end state, the intermediate focal length state, and the telephoto end state, respectively.

FIG. 24 is a sectional view showing a mechanism of the variable focal length lens relating to the ninth Example.

FIGS. 25A, 25B and 25C show diagrams of coma aberrations for d-line (wavelength λ=587.6 nm) in the infinite focusing state of the variable focal length lens relating to the ninth Example after adjustment of decentering error having occurred in the manufacture by means of the second and third adjustment mechanisms, and FIGS. 25A, 25B and 25C indicate the wide angle end state, the intermediate focal length state, and the telephoto end state, respectively.

FIG. 26 is a sectional view showing a mechanism of the variable focal length lens relating to the tenth Example.

FIGS. 27A, 27B and 27C show diagrams of coma aberrations for d-line (wavelength λ=587.6 nm) in the infinite focusing state of the variable focal length lens relating to the tenth Example after adjustment of decentering error having occurred in the manufacture by means of the second and fourth adjustment mechanisms, and FIGS. 27A, 27B and 27C indicate the wide angle end state, the intermediate focal length state, and the telephoto end state, respectively.

FIG. 28 is a view showing a camera equipped with the variable focal length lens of the present application.

FIG. 29 is a view schematically showing a method for adjusting the variable focal length lens of the present application.

### DESCRIPTION OF EMBODIMENTS

A variable focal length lens relating to an embodiment of the present application and a method for adjusting the variable focal length lens are explained below. In addition, the embodiments as described below are exemplified to prompt the understanding of the present invention, and it is not intended to exclude additions, alternatives and so on that a person having ordinary skill in the art can carry out within a scope of the technical concept of the present invention.

Further, in the present specification, shift decentering means that a lens group or a part of a lens group is shifted in a direction orthogonal to an optical axis of a variable focal length lens, and tilt decentering means that a lens group or a part of a lens group is tilted so as to include a component in a direction orthogonal to an optical axis of a variable focal length lens.

The variable focal length lens of the present application is configured to comprise, in order from an object side, a first lens group having negative refractive power and a second lens group having positive refractive power, a focal length being varied by changing an air space between the first lens group and the second lens group, and the adjustment mechanism being provided, the adjustment mechanism performing a position adjustment for making shift decentering or tilt decentering of a partial lens group of the first lens group and a partial lens group of the second lens group, after assembling the first lens group and the second lens group.

With this configuration, in the variable focal length lens of the present application, it is possible to satisfactorily correct deterioration of an imaging performance owing to decentering aberration caused by decentering error in the manufacture, in the entire focal length range from a wide angle end state to a telephoto end state.

If, as in a conventional manner, decentering error is corrected by the adjustment mechanism of only one of a whole or a partial lens group of first lens group and a partial lens group of second lens group, an imaging performance becomes worse. Because, in only a small part of the entire focal length range, decentering aberration is corrected satisfactorily, and in the remaining focal length range, it remains without being corrected. This trouble becomes more serious as a zoom ratio of the variable focal length lens is larger. For solving the trouble, the variable focal length lens of the present application adopts the above-mentioned configuration, whereby satisfactorily correction is achieved in the entire focal length range.

Further, in the variable focal length lens of the present application, it is preferable to satisfy the following conditional expressions:

2.0<MAt/MAw (1)

MBt/MBw<2.0 (2)

where MAt denotes a composite imaging magnification of a lens group positioned between the whole or the partial lens group of the first lens group subjected to the shift decentering or the tilt decentering and an image surface, in a telephoto end state of the variable focal length lens, MAw denotes a composite imaging magnification of the lens group positioned between the whole or the partial lens group of the first lens group subjected to the tilt decentering or the shift decentering and the image surface, in a wide angle end state of the variable focal length lens, MBt denotes a composite imaging magnification of a lens group positioned between the partial lens group of the second lens group subjected to the shift decentering or the tilt decentering and the image surface, in the telephoto end state of the variable focal length lens, and MBw denotes a composite imaging magnification of the lens group positioned between the partial lens group of the second lens group subjected to the shift decentering or the tilt decentering and the image surface, in the wide angle end state of the variable focal length lens. In addition, MBt=MBw=1 is set on condition that no lens group exists between the partial lens group of the second lens group and the image surface.

The conditional expressions (1) and (2) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making shift decentering or tilt decentering of the partial lens group of the first lens group and the partial lens group of the second lens group of the variable focal length lens.

In the variable focal length lens of the present application, it is possible to realize satisfactory correction in the entire focal length range from the wide angle end state to the telephoto end state by making a variation in a composite imaging magnification of the lens group positioned between the whole or the partial lens group of the first lens group and the image surface larger than a variation in a composite imaging magnification of the lens group positioned between the partial lens group of the second lens group and the image surface.

When the value of MAt/MAw is equal to or falls the lower limit value of the conditional expression (1), it is difficult to correct decentering aberration in the entire focal region from the wide angle end state to the telephoto end state.

When the value of MBt/MBw is equal to or exceeds the higher limit value of the conditional expression (2), it is difficult to correct decentering aberration in the entire focal region range from the wide angle end state to the telephoto end state.

In addition, in order to attain the advantageous effect of the embodiment surely, it is preferable to set the lower limit value of the conditional expression (1) to 2.5.

Further, in order to attain the advantageous effect of the embodiment surely, it is preferable to set the higher limit value of the conditional expression (2) to 1.5.

Further, in the variable focal length lens of the present application, it is preferable to employ such configuration that the second lens group comprises a vibration reduction lens group to be moved so as to include a component in a direction orthogonal to an optical axis. With this configuration, in the variable focal length lens of the present application, it is possible to satisfactorily correct deterioration of an imaging performance owing to image blurring occurring at photographing caused by a camera shake or the like, in the entire focal length range from the wide angle end state to the telephoto end state.

Further, in the variable focal length lens of the present application, it is preferable to employ such configuration that the first lens group comprises a positive lens on the most image side, and the adjustment mechanism performs a position adjustment for making shift decentering of the positive lens on the most image side in the first lens group and a position adjustment for making tilt decentering of a lens group on the most object side in the second lens group. With this configuration, in the variable focal length lens of the present application, it is possible to realize satisfactory correction of decentering aberration in the entire focal length range from the wide angle end state to the telephoto end state, by using the adjustment mechanism to perform a position adjustment for making shift decentering of the positive lens on the most image side in the first lens group and a position adjustment for making tilt decentering of the lens group on the most object side in the second lens group.

In the variable focal length lens of the present application, it is preferable to satisfy the following conditional expressions:

2.0<MAt/MAw (3)

MBt/MBw<−3.0 (4)

where MAt denotes a composite imaging magnification of a lens group positioned between the positive lens on the most image side in the first lens group and an image surface, in a telephoto end state of the variable focal length lens, MAw denotes a composite imaging magnification of the lens group positioned between the positive lens on the most image side in the first lens group and the image surface, in a wide angle end state of the variable focal length lens, MBt denotes a composite imaging magnification of a lens group positioned between the lens group on the most object side in the second lens group and the image surface, in the telephoto end state of the variable focal length lens, and MBw denotes a composite imaging magnification of the lens group positioned between the lens group on the most object side in the second lens group and the image surface, in the wide angle end state of the variable focal length lens.

The conditional expressions (3) and (4) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making shift decentering of the positive lens on the most image side in the first lens group of the variable focal length lens and a position adjustment for making tilt decentering of the lens group on the most object side in the second lens group.

In the variable focal length lens of the present application, it is possible to realize satisfactory correction in the entire focal length range from the wide angle end state to the telephoto end state by making a variation in a composite imaging magnification of the lens group positioned between the positive lens on the most image side in the first lens group and the image surface larger than a variation in a composite imaging magnification of the lens group positioned between the lens group on the most object side in the second lens group and the image surface. In addition, it is more preferable to set the lower limit value of the conditional expression (3) to 2.5. Further, it is more preferable to set the higher limit value of the conditional expression (4) to −4.5.

Further, in the variable focal length lens of the present application, it is preferable that a positive lens is provided on the most image side in the first lens group, the second lens group comprises a vibration reduction lens group to be moved so as to include a component in a direction orthogonal to an optical axis, the adjustment mechanism performs a position adjustment for making shift decentering of the positive lens on the most image side in the first lens group and a position adjustment for making tilt decentering of the partial lens group of the second lens group, and the vibration reduction lens group performs vibration reduction by making shift decentering of the partial lens group of the second lens group.

With this configuration, in the variable focal length lens of the present application, it is possible to realize satisfactory correction of decentering aberration in the entire focal length range from the wide angle end state to the telephoto end state, by using the adjustment mechanism to perform a position adjustment for making shift decentering of the positive lens on the most image side in the first lens group and a position adjustment for making tilt decentering of the partial lens group of the second lens group and by enabling the vibration reduction lens group to perform vibration reduction by making shift decentering of the partial lens group of the second lens group.

Further, in the variable focal length lens of the present application, it is preferable to satisfy the following conditional expressions:

2.0<MAt/MAw (5)

MBt/MBw<2.0 (6)

where MAt denotes a composite imaging magnification of a lens group positioned between the positive lens on the most image side in the first lens group and an image surface, in a telephoto end state of the variable focal length lens, MAw denotes a composite imaging magnification of the lens group positioned between the positive lens on the most image side in the first lens group and the image surface, in a wide angle end state of the variable focal length lens, MBt denotes a composite imaging magnification of a lens group positioned between the vibration reduction lens group and the image surface, in the telephoto end state of the variable focal length lens, and MBw denotes a composite imaging magnification of the lens group positioned between the vibration reduction lens group and the image surface, in the wide angle end state of the variable focal length lens. In addition, MBt=MBw=1 is set on condition that no lens group exists between the vibration reduction lens group and the image surface.

The conditional expressions (5) and (6) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making shift decentering of the positive lens on the most image side in the first lens group of the variable focal length lens and a position adjustment for making tilt decentering of the partial lens group of the second lens group.

In the variable focal length lens of the present application, it is possible to realize satisfactory correction in the entire focal length range from the wide angle end state to the telephoto end state by making a variation in a composite imaging magnification of the lens group positioned between the positive lens on the most image side in the first lens group and the image surface larger than a variation in a composite imaging magnification of the lens group positioned between the partial lens group of the second lens group and the image surface. In addition, it is more preferable to set the lower limit value of the conditional expression (5) to 2.5. Further, it is more preferable to set the higher limit value of the conditional expression (6) to 1.0.

Further, in the variable focal length lens of the present application, it is preferable to employ such configuration that a positive lens is provided on the most image side in the first lens group, the second lens group comprises a vibration reduction lens group to be moved so as to include a component in a direction orthogonal to an optical axis, and includes a negative lens group positioned on an image side of the vibration reduction lens group, and the adjustment mechanism performs a position adjustment for making shift decentering of the positive lens on the most image side in the first lens group and a position adjustment for making shift decentering of the negative lens group positioned on the image side of the vibration reduction lens group.

With this configuration, in the variable focal length lens of the present application, it is possible to realize satisfactory correction of decentering aberration in the entire focal length range from the wide angle end state to the telephoto end state, by using the adjustment mechanism to perform a position adjustment for making shift decentering of the positive lens on the most image side in the first lens group and a position adjustment for making shift decentering of the negative lens group positioned on the image side of the vibration reduction lens group in the second lens group.

Further, in the variable focal length lens of the present application, it is preferable to satisfy the following conditional expressions:

2.0<MAt/MAw (7)

MBt/MBw<2.0 (8)

where MAt denotes a composite imaging magnification of a lens group positioned between the positive lens on the most image side in the first lens group and an image surface, in a telephoto end state of the variable focal length lens, MAw denotes a composite imaging magnification of the lens group positioned between the positive lens on the most image side in the first lens group and the image surface, in a wide angle end state of the variable focal length lens, MBt denotes a composite imaging magnification of a lens group positioned between the negative lens group positioned on the image side of the vibration reduction lens group in the second lens group and the image surface, in the telephoto end state of the variable focal length lens, and MBw denotes a composite imaging magnification of the lens group positioned between the negative lens group positioned on the image side of the vibration reduction lens group in the second lens group and the image surface, in the wide angle end state of the variable focal length lens. In addition, MBt=MBw=1 is set on condition that no lens group exists between the negative lens group L8 and the image surface.

The conditional expressions (7) and (8) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making shift decentering of the positive lens on the most image side in the first lens group of the variable focal length lens and a position adjustment for making shift decentering of the negative lens group positioned on the image side of the vibration reduction lens group in the second lens group.

In the variable focal length lens of the present application, it is possible to realize satisfactory correction of decentering aberration in the entire focal length range from the wide angle end state to the telephoto end state by making a variation in a composite imaging magnification of the lens group positioned between the positive lens on the most image side in the first lens group and the image surface larger than a variation in a composite imaging magnification of the lens group positioned between the negative lens group positioned on the image side of the vibration reduction lens group in the second lens group and the image surface. In addition, it is more preferable to set the lower limit value of the conditional expression (7) to 2.5. Further, it is more preferable to set the higher limit value of the conditional expression (8) to 1.3.

Further, in the variable focal length lens of the present application, it is preferable a positive lens is provided on the most image side in the first lens group and a positive lens is provided on the most image side in the second lens group, and the adjustment mechanism performs a position adjustment for making shift decentering of the positive lens on the most image side in the first lens group and a position adjustment for making shift decentering of the positive lens on the most image side in the second lens group.

With this configuration, in the variable focal length lens of the present application, it is possible to realize satisfactory correction of decentering aberration in the entire focal length range from the wide angle end state to the telephoto end state, by using the adjustment mechanism to perform a position adjustment for making shift decentering of the positive lens on the most image side in the first lens group and a position adjustment for making shift decentering of the positive lens on the most image side in the second lens group.

Further, in the variable focal length lens of the present application, it is preferable to satisfy the following conditional expression:

2.0<MAt/MAw (9)

where MAt denotes a composite imaging magnification of a lens group positioned between the positive lens of the first lens group and an image surface, in a telephoto end state of the variable focal length lens, and MAw denotes a composite imaging magnification of the lens group positioned between the positive lens of the first lens group and the image surface, in a wide angle end state of the variable focal length lens.

The conditional expression (9) defines the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making shift decentering of the positive lens on the most image side in the first lens group of the variable focal length lens and a position adjustment for making shift decentering of the positive lens on the most image side in the second lens group.

In the variable focal length lens of the present application, it is possible to realize satisfactory correction of an image performance in the entire focal length range from the wide angle end state to the telephoto end state by enlarging a variation in a composite imaging magnification of the lens group positioned between the positive lens on the most image side in the first lens group and the image surface. In addition, it is more preferable to set the lower limit value of the conditional expression (9) to 2.5.

Further, in the variable focal length lens of the present application, it is preferable to employ such configuration that the second lens group comprises a vibration reduction lens group to be moved so as to include a component in a direction orthogonal to an optical axis, and includes a negative lens group positioned on an image side of the vibration reduction lens group, and the adjustment mechanism performs a position adjustment for making tilt decentering of the first lens group and a position adjustment for making shift decentering of the negative lens group positioned on the image side of the vibration reduction lens group.

With this configuration, in the variable focal length lens of the present application, it is possible to realize satisfactory correction of decentering aberration in the entire focal length range from the wide angle end state to the telephoto end state, by using the adjustment mechanism to perform a position adjustment for making tilt decentering of the first lens group and a position adjustment for making shift decentering of the negative lens group positioned on the image side of the vibration reduction lens group in the second lens group.

Further, in the variable focal length lens of the present application, it is preferable to satisfy the following conditional expressions:

2.0<MAt/MAw (10)

MBt/MBw<2.0 (11)

where MAt denotes a composite imaging magnification of a lens group positioned between the first lens group and an image surface, in a telephoto end state of the variable focal length lens, MAw denotes a composite imaging magnification of the lens group positioned between the first lens group and the image surface, in a wide angle end state of the variable focal length lens, MBt denotes a composite imaging magnification of a lens group positioned between the negative lens group positioned on the image side of the vibration reduction lens group in the second lens group and the image surface, in the telephoto end state of the variable focal length lens, and

MBw denotes a composite imaging magnification of the lens group positioned between the negative lens group positioned on the image side of the vibration reduction lens group in the second lens group and the image surface, in the wide angle end state of the variable focal length lens. In addition, MBt=MBw=1 is set on condition that no lens group exists between the negative lens group positioned on the image side of the vibration reduction lens group in the second lens group and the image surface.

The conditional expressions (10) and (11) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making tilt decentering of the first lens group of the variable focal length lens and a position adjustment for making shift decentering of the negative lens group positioned on the image side of the vibration reduction lens group in the second lens group.

In the variable focal length lens of the present application, it is possible to realize satisfactory correction of an imaging performance in the entire focal length range from the wide angle end state to the telephoto end state by making a variation in a composite imaging magnification of the lens group positioned between the first lens group and the image surface larger than a variation in a composite imaging magnification of the lens group positioned between the negative lens group positioned on the image side of the vibration reduction lens group in the second lens group and the image surface. In addition, it is more preferable to set the lower limit value of the conditional expression (10) to 2.5. Further, it is more preferable to set the higher limit value of the conditional expression (11) to 1.3.

Further, in the variable focal length lens of the present application, it is preferable to employ such configuration that a positive lens is provided on the most image side in the second lens group and the adjustment mechanism performs a position adjustment for making tilt decentering of the whole first lens group and a position adjustment for making shift decentering of the positive lens positioned on the most image side in the second lens group. With this configuration, in the variable focal length lens of the present application, it is possible to realize satisfactory correction of decentering aberration in the entire focal length range from the wide angle end state to the telephoto end state, by using the adjustment mechanism to perform a position adjustment for making tilt decentering of the first lens group and a position adjustment for making shift decentering of the positive lens on the most image side in the second lens group.

Further, in the variable focal length lens of the present application, it is preferable to satisfy the following conditional expression:

2.0<MAt/MAw (12)

where MAt denotes a composite imaging magnification of a lens group positioned between the first lens group and an image surface, in a telephoto end state of the variable focal length lens, and MAw denotes a composite imaging magnification of the lens group positioned between the first lens group and the image surface, in a wide angle end state of the variable focal length lens.

The conditional expression (12) defines the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making tilt decentering of the first lens group of the variable focal length lens and a position adjustment for making shift decentering of the positive lens on the most image side in the second lens group.

In the variable focal length lens of the present application, it is possible to realize satisfactory correction of decentering aberration in the entire focal length range from the wide angle end state to the telephoto end state by enlarging a variation in a composite imaging magnification of the lens group positioned between the first lens group and the image surface. In addition, it is more preferable to set the lower limit value of the conditional expression (12) to 2.5.

Further, in the variable focal length lens of the present application, it is preferable to employ such configuration that a positive lens is provided on the most image side in the first lens group and the adjustment mechanism performs a position adjustment for making tilt decentering of the positive lens on the most image side in the first lens group and a position adjustment for making tilt decentering a lens group on the most object side in the second lens group. With this configuration, in the variable focal length lens of the present application, it is possible to realize satisfactory correction of decentering aberration in the entire focal length range from the wide angle end state to the telephoto end state, by using the adjustment mechanism to perform a position adjustment for making tilt decentering of the positive lens on the most image side in the first lens group and a position adjustment for making tilt decentering of an lens group on the most object side in the second lens group.

Further, in the variable focal length lens of the present application, it is preferable to satisfy the following conditional expressions:

2.0<MAt/MAw (13)

MBt/MBw<−3.0 (14)

where MAt denotes a composite imaging magnification of a lens group positioned between the positive lens on the most image side in the first lens group and an image surface, in a telephoto end state of the variable focal length lens, MAw denotes a composite imaging magnification of the lens group positioned between the positive lens on the most image side in the first lens group and the image surface, in a wide angle end state of the variable focal length lens, MBt denotes a composite imaging magnification of a lens group positioned between the lens group on the most object side in the second lens group and the image surface, in the telephoto end state of the variable focal length lens, and MBw denotes a composite imaging magnification of the lens group positioned between the lens group on the most object side in the second lens group and the image surface, in the wide angle end state of the variable focal length lens.

The conditional expressions (13) and (14) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making tilt decentering of the positive lens on the most image side in the first lens group of the variable focal length lens and a position adjustment for making tilt decentering of the lens group on the most object side in the second lens group.

In the variable focal length lens of the present application, it is possible to realize satisfactory correction of an image performance in the entire focal length range from the wide angle end state to the telephoto end state by making a variation in a composite imaging magnification of the lens group positioned between the positive lens on the most image side in the first lens group and the image surface larger than a variation in a composite imaging magnification of the lens group positioned between the lens group on the most object side in the second lens group and the image surface. In addition, it is more preferable to set the lower limit value of the conditional expression (13) to 2.5. Further, it is more preferable to set the higher limit value of the conditional expression (14) to −4.5.

Further, in the variable focal length lens of the present application, it is preferable to employ such configuration that a positive lens is provided on the most image side in the first lens group, the second lens group comprises a vibration reduction lens group to be moved so as to include a component in a direction orthogonal to an optical axis, the adjustment mechanism performs a position adjustment for making tilt decentering of the positive lens on the most image side in the first lens group and a position adjustment for making tilt decentering of the partial lens group of the second lens group, and the vibration reduction lens group performs vibration reduction by making shift decentering of the partial lens group of the second lens group. With this configuration, in the variable focal length lens of the present application, it is possible to realize satisfactory correction of decentering aberration in the entire focal length range from the wide angle end state to the telephoto end state, by using the adjustment mechanism to perform a position adjustment for making tilt decentering of the positive lens on the most image side in the first lens group and a position adjustment for making tilt decentering of the partial lens group of the second lens group.

Further, in the variable focal length lens of the present application, it is preferable to satisfy the following conditional expressions:

2.0<MAt/MAw (15)

MBt/MBw<2.0 (16)

where MAt denotes a composite imaging magnification of a lens group positioned between the positive lens on the most image side in the first lens and an image surface, in a telephoto end state of the variable focal length lens, MAw denotes a composite imaging magnification of the lens group positioned between the positive lens on the most image side in the first lens and the image surface, in a wide angle end state of the variable focal length lens, MBt denotes a composite imaging magnification of a lens group positioned between the vibration reduction lens group in the second lens group and the image surface, in the telephoto end state of the variable focal length lens, and MBw denotes a composite imaging magnification of the lens group positioned between the vibration reduction lens group in the second lens group and the image surface, in the wide angle end state of the variable focal length lens. In addition, MBt=MBw=1 is set on condition that no lens group exists between the vibration reduction lens group in the second lens group and the image surface.

The conditional expressions (15) and (16) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making tilt decentering of the positive lens on the most image side in the first lens group of the variable focal length lens and a position adjustment for making tilt decentering of the partial lens group of the second lens group.

In the variable focal length lens of the present application, it is possible to realize satisfactory correction of an imaging performance in the entire focal length range from the wide angle end state to the telephoto end state by making a variation in a composite imaging magnification of the lens group positioned between the positive lens on the most image side in the first lens group and the image surface larger than a variation in a composite imaging magnification of the lens group positioned between the vibration reduction lens group and in the second lens group and the image surface. In addition, it is more preferable to set the lower limit value of the conditional expression (15) to 2.5. Further, it is more preferable to set the higher limit value of the conditional expression (16) to 1.0.

Further, in the variable focal length lens of the present application, it is preferable to employ such configuration that a positive lens is provided on the most image side in the first lens group, the second lens group comprises a vibration reduction lens group to be moved so as to include a component in a direction orthogonal to an optical axis, and includes a negative lens group positioned on an image side of the vibration reduction lens group, and the adjustment mechanism performs a position adjustment for making tilt decentering of the positive lens on the most image side in the first lens group and a position adjustment for making shift decentering of the negative lens group positioned on the image side of the vibration reduction lens group. With this configuration, in the variable focal length lens of the present application, it is possible to realize satisfactory correction of decentering aberration in the entire focal length range from the wide angle end state to the telephoto end state, by using the adjustment mechanism to perform a position adjustment for making tilt decentering of the positive lens on the most image side in the first lens group and a position adjustment for making shift decentering of the negative lens group positioned on the image side of the vibration reduction lens group in the second lens group.

Further, in the variable focal length lens of the present application, it is preferable to satisfy the following conditional expressions:

2.0<MAt/MAw (17)

MBt/MBw<2.0 (18)

where MAt denotes a composite imaging magnification of a lens group positioned between the positive lens on the most image side in the first lens group and an image surface, in a telephoto end state of the variable focal length lens, MAw denotes a composite imaging magnification of the lens group positioned between the positive lens on the most image side in the first lens group and the image surface, in a wide angle end state of the variable focal length lens, MBt denotes a composite imaging magnification of a lens group positioned between the negative lens group positioned on the image side of the vibration reduction lens group in the second lens group and the image surface, in the telephoto end state of the variable focal length lens, and MBw denotes a composite imaging magnification of the lens group positioned between the negative lens group positioned on the image side of the vibration reduction lens group in the second lens group and the image surface, in the wide angle end state of the variable focal length lens. In addition, MBt=MBw=1 is set on condition that no lens group exists between the negative lens group and the image surface.

The conditional expressions (17) and (18) define the magnification relation of lens groups suitable to satisfactorily correct deterioration of an imaging performance owing to decentering aberration in the entire focal length range from the wide angle end state to the telephoto end state of the variable focal length lens, by using the adjustment mechanism to perform a position adjustment for making tilt decentering of the positive lens on the most image side in the first lens group of the variable focal length lens and a position adjustment for making shift decentering of the negative lens group positioned on the image side of the vibration reduction lens group in the second lens group.

In the variable focal length lens of the present application, it is possible to realize satisfactory correction of decentering aberration in the entire focal length range from the wide angle end state to the telephoto end state by making a variation in a composite imaging magnification of the lens group positioned between the positive lens on the most image side in the first lens group and the image surface larger than a variation in a composite imaging magnification of the lens group positioned between the negative lens group positioned on the image side of the vibration reduction lens group in the second lens group and the image surface. In addition, it is more preferable to set the lower limit value of the conditional expression (17) to 2.5. Further, it is more preferable to set the higher limit value of the conditional expression (18) to 1.3

Further, in the variable focal length lens of the present application, it is preferable to employ such configuration that a positive lens is provided on the most image side in the first lens group and a positive lens is provided on the most image side in the second lens group, and the adjustment mechanism performs a position adjustment for making tilt decentering of the positive lens on the most image side in the first lens group and a position adjustment for making shift decentering of the positive lens on the most image side in the second lens group.

With this configuration, in the variable focal length lens of the present application, it is possible to realize satisfactory correction of decentering aberration in the entire focal length range from the wide angle end state to the telephoto end state, by using the adjustment mechanism to perform a position adjustment for making tilt decentering of the positive lens on the most image side in the first lens group and a position adjustment for making shift decentering of the positive lens on the most image side in the second lens group.

Further, in the variable focal length lens of the present application, it is preferable to satisfy the following conditional expression:

2.0<MAt/MAw (19)

where MAt denotes a composite imaging magnification of a lens group positioned between the positive lens on the most image side in the first lens group and an image surface, in a telephoto end state of the variable focal length lens, and MAw denotes a composite imaging magnification of the lens group positioned between the positive lens on the most image side in the first lens group and the image surface, in a wide angle end state of the variable focal length lens.

The conditional expression (19) defines the magnification relation of lens groups suitable to satisfactorily correct deterioration of an imaging performance owing to decentering aberration in the entire focal length range from the wide angle end state to the telephoto end state, by using the adjustment mechanism to perform a position adjustment for making tilt decentering of the positive lens on the most image side in the first lens group of the variable focal length lens and a position adjustment for making shift decentering of the positive lens on the most image side in the second lens group.

In the variable focal length lens of the present application, it is possible to realize satisfactory correction of decentering aberration in the entire focal length range from the wide angle end state to the telephoto end state by enlarging a variation in a composite imaging magnification of the lens group positioned between the positive lens on the most image side in the first lens group and the image surface. In addition, it is more preferable to set the lower limit value of the conditional expression (19) to 2.5.

Further, in the variable focal length lens of the present application, it is preferable to employ such configuration that an iris stop is provided and the iris stop is moved integrally with the second lens group when the focal length is varied. With this configuration, in the variable focal length lens of the present application, it is possible to satisfactorily correct various aberrations and achieve a high imaging performance, in the entire focal length range from the wide angle end state to the telephoto end state

A variable focal length lens adjusting method of the present application is a method for adjusting a variable focal length lens which comprises, in order from an object side, a first lens group having negative refractive power and a second lens group having positive refractive power, a focal length being varied by changing an air space between the first lens group and the second lens group; the adjustment in the method being performed by the adjustment mechanism for performing a position adjustment for making shift decentering or tilt decentering of a whole or a partial lens group of the first lens group and a partial lens group of the second lens group, after assembling the first lens group and the second lens group.

With this configuration, in the variable focal length lens, it is possible to conduct decentering adjustment readily and achieve a high imaging performance with reduction of a cost.

### Examples of Present Application

Various examples of the variable focal length lens of the present application are explained as hereinbelow. The following first to tenth Examples of the present application present application are different in adjustment portions of lenses equipped with adjustment mechanisms for satisfactorily correcting deterioration of an imaging performance owing to decentering error in the manufacture, but optical specifications of the variable focal length lens itself are in common. Therefore, common portions are collectively described here.

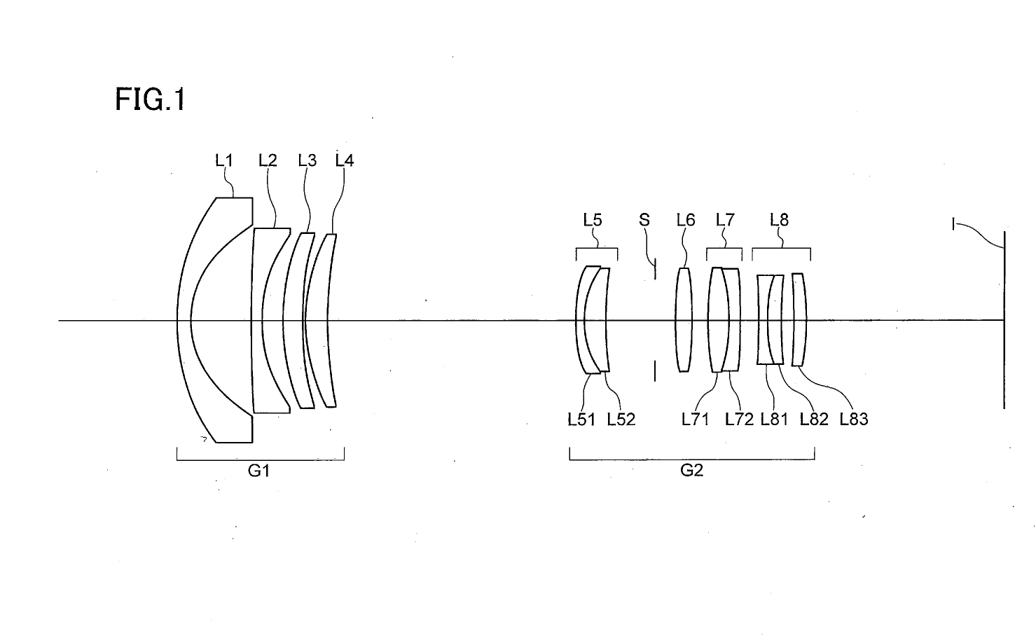

FIG. 1 is a sectional view showing a configuration of a variable focal length lens relating to the first to tenth Examples. As shown in FIG. 1, the variable focal length lens relating to the first to tenth Examples is composed of a first lens group G1 having negative refractive power and a second lens group G2 having positive refractive power, and has such configuration that an air space of the first lens group G1 and the second lens group G2 is varied upon zooming from a wide angel end state to a telephoto end state.

The first lens group G1 is composed of, in order from an object side, a negative meniscus lens L1 having a convex surface facing the object side, a negative meniscus lens L2 having a convex surface facing the object side, and a positive meniscus lens L3 having a convex surface facing the object side.

The second lens group G2 is composed of, in order from the object side, a lens group L5 having a convex surface facing the object side, an iris stop S, a positive lens L6 having a double convex shape, a lens group L7 having a convex surface facing the object side, and a lens group L8 composed of a cemented lens having a concave surface facing the object side and a positive meniscus lens having a concave surface facing the object side.

The lens group L5 of the second lens group G2 is composed of a cemented lens constructed by a negative meniscus lens L51 having a convex surface facing the object side cemented with a positive meniscus lens L52 having a convex surface facing the object side. As for the negative meniscus lens L51 having a convex surface facing the object side, its object side is formed into an aspherical shape.

The lens group L7 of the second lens group G2 is composed of a cemented lens constructed by a positive lens L71 having a double convex shape cemented with a negative meniscus lens L72 having a concave surface facing the object side.

The lens group L8 of the second lens group G2 is composed of a cemented lens constructed by a negative lens L81 having a double concave shape cemented with a positive meniscus lens L82 having a convex surface facing the object side, and a positive meniscus lens L83 having a concave surface facing the object side.

Table 1 below shows values of optical specifications of the variable focal length lens relating to the first to tenth Examples. In [Various Data] in Table 1, W denotes a wide angle end state, M denotes an intermediate focal length state, T denotes a telephoto end state, f denotes a focal length, FNO denotes an F-number, 2ω denotes an angle of view (unit: “°”), Y denotes an image height, TL denotes a total length of the variable focal length lens, and B.f. denotes a back focus, respectively.

In [Surface Data], the first column N denotes a number of a lens surface counted from the object side, the second column r denotes a radius of curvature of the lens surface, the third column d denotes a lens surface-to-lens surface distance, the fourth column nd denotes refractive index for d-line (wavelength λ=587.6 nm), the fifth column νd denotes an Abbe number, B.f. denotes aback focus, OP denotes an object surface, and I denotes an imaging surface. Meanwhile, a radius of curvature r=∞ in the column r denotes a plane surface, and refractive index of air nd=1.00000 is omitted in the description.

In [Aspherical Data], an aspherical surface coefficient is shown in the case where a shape of an aspherical surface shape is exhibited by the following expression:

x=(h²/r)/[1+[1−κ(h/r)²]^{(1/2)}]+A4h⁴+A6h⁶+A8h⁸+A10h¹⁰

where x denotes a displacement (a sag amount) in a direction of an optical axis at a height h from the optical axis taking a vertex of the surface as a reference, κ denotes a conical coefficient, A4, A6, A8 and A10 denote respective aspherical surface coefficients, and r denotes a paraxial radius of curvature shown in [Surface Data]. The secondary aspherical surface coefficient A2 is omitted in the description. “E−n” on the table denotes “10⁻ⁿ”.

In [Variable Surface to surface Distance], surface to surface distances in the focal lengths of W, M and T are shown. In [Zoom Lens Group Data], the starting surface number ST and the focal length f are shown for each lens group.

In addition, when no special mention is made in all the following values of specifications, “mm” is generally used for the unit of length such as the focal length f, the radius of curvature r and the unit for other lengths as shown. However, since similar optical performance can be obtained even if an optical system is proportionally enlarged or reduced, the unit is not necessarily to be limited. Other suitable units may be used without being limited to “mm”. Further, since the above-mentioned description of the reference symbols is the same for other Examples as mentioned hereinafter, it is omitted there.

TABLE 1
[Various Data]
Zoom Ratio 2.8252

| | W | M | T |
|---|---|---|---|
| f | 10.300 | 18.000 | 29.100 |
| FNO | 3.59 | 4.41 | 5.80 |
| 2ω | 76.64 | 49.30 | 31.51 |
| Y | 8.22 | 8.22 | 8.22 |
| TL | 77.50 | 72.09 | 77.89 |
| B.f. | 18.424 | 27.535 | 40.840 |

[Surface Data]

| N | r | d | nd | νd |
|---|---|---|---|---|
| OP | ∞ | ∞ | | |
| 1 | 21.7269 | 1.30 | 1.85135 | 40.1 |
| 2 | 9.4719 | 5.75 | | |
| 3 | 111.4840 | 1.00 | 1.88300 | 40.76 |
| 4 | 14.9963 | 1.95 | | |
| 5 | 22.2590 | 1.90 | 1.84666 | 23.78 |
| 6 | 33.3223 | 0.20 | | |
| 7 | 18.7069 | 2.10 | 1.80809 | 22.79 |
| 8 | 42.8001 | (d8) | | |
| 9 | 15.0616 | 0.80 | 1.83441 | 37.28 |
| 10 | 9.5077 | 2.00 | 1.72916 | 54.66 |
| 11 | 32.9673 | 4.7474 | | |
| 12 | ∞ | 1.85 | | (Iris Stop) |
| 13 | 34.6096 | 1.55 | 1.48749 | 70.45 |
| 14 | −34.6096 | 1.50 | | |
| 15 | 27.0404 | 2.00 | 1.58313 | 59.38 |
| 16 | −17.0002 | 1.00 | 1.68893 | 31.06 |
| 17 | −70.6449 | 1.75 | | |
| 18 | −73.1879 | 0.80 | 1.80610 | 40.94 |
| 19 | 14.1510 | 1.30 | 1.67790 | 55.4 |
| 20 | 36.2665 | 1.15 | | |
| 21 | −64.5797 | 1.15 | 1.73077 | 40.51 |
| 22 | −30.4612 | B.f. | | |
| I | ∞ | | | |

[Aspherical Data]

N:2
κ = 0.4886
A4 = 1.6354E−05
A6 = 4.5866E-07
A8 = −4.8900E−09
A10 = 3.8661E−11
N:9
κ = 1.000
A4 = −2.1700E−05
A6 = −1.5500E−07
A8 = 0.0000E+00
A10 = 0.0000E+00
N:22
κ = 4.0626
A4 = 8.2358E−05
A6 = 4.9830E−07
A8 = −3.2537E−09
A10 = 0.0000E+00

[Variable Surface to surface Distance]

| | W | M | T |
|---|---|---|---|
| d8 | 23.398 | 8.803 | 1.357 |

[Zoom Lens Group Data]

| G | ST | f |
|---|---|---|
| 1 | 1 | −17.17 |
| 2 | 9 | 20.44 |

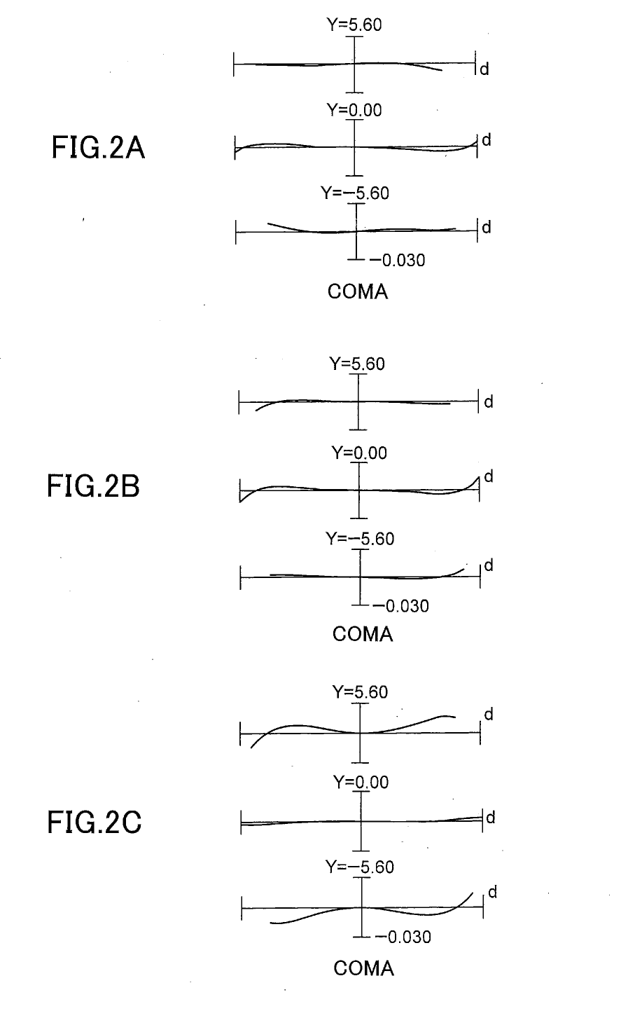

FIGS. 2A, 2B and 2C show diagrams of coma aberrations for d-line (wavelength λ=587.6 nm) in an infinite focusing state of the variable focal length lens relating to the first to tenth Examples in case of no occurrence of decentering error in the manufacture, and FIGS. 2A, 2B and 2C indicate a wide angle end state, an intermediate focal length state, and a telephoto end state, respectively.

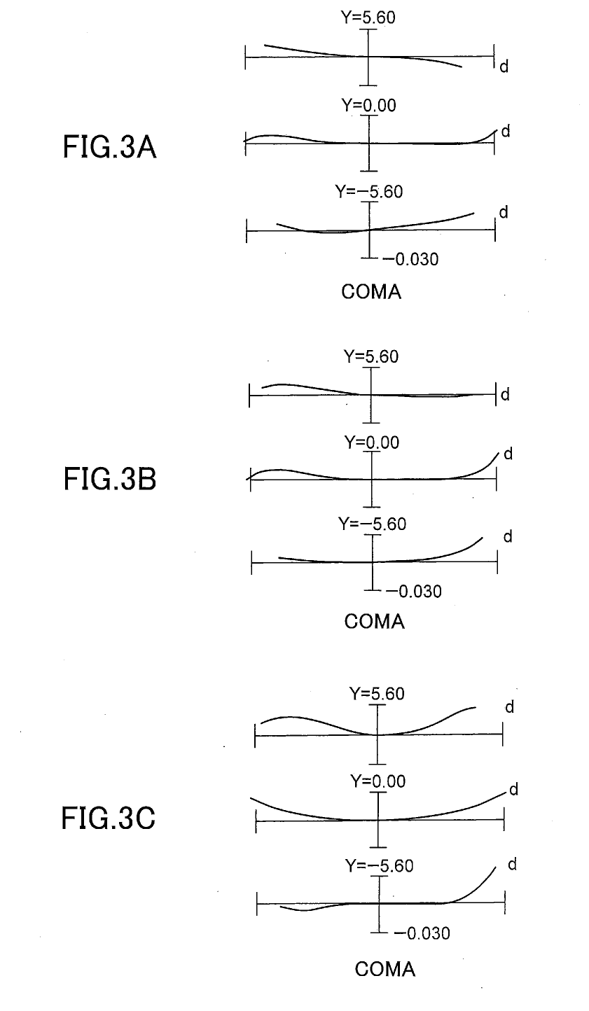

FIGS. 3A, 3B and 3C show diagrams of coma aberrations for d-line (wavelength λ=587.6 nm) in the infinite focusing state of the variable focal length lens relating to the first to tenth Examples in case of occurrence of decentering error in the manufacture, and FIGS. 3A, 3B and 3C indicate the wide angle end state, the intermediate focal length state, and the telephoto end state, respectively.

In the diagrams of coma aberrations shown in FIGS. 2A, 2B and 2C and FIGS. 3A, 3B and 3C, Y denotes an image height (unit: “mm”), and coma aberrations at respective image heights are shown. This is the same for other diagrams of aberrations as referred to in the description as mentioned hereinbelow.

From FIGS. 2A, 2B and 2C and FIGS. 3A, 3B and 3C, it is recognized that a coma aberration becomes worse owing to decentering error in the manufacture. In each of the Examples as mentioned below, it is shown that the adjustment mechanism adjusts decentering aberration to achieve satisfactory correction of the coma aberration.

### First Example

Next, the adjustment mechanism of the variable focal length lens relating to the first Example of the present application is explained with reference to the accompanying drawings. In the first Example, so as to satisfactorily correct deterioration of an imaging performance owing to decentering error in the manufacture, there is provided the adjustment mechanism to perform a position adjustment for making shift decentering of the positive meniscus lens L4 on the most image side in the first lens group G1 and a position adjustment for making tilt decentering of the lens group L5 on the most object side in the second lens group G2.

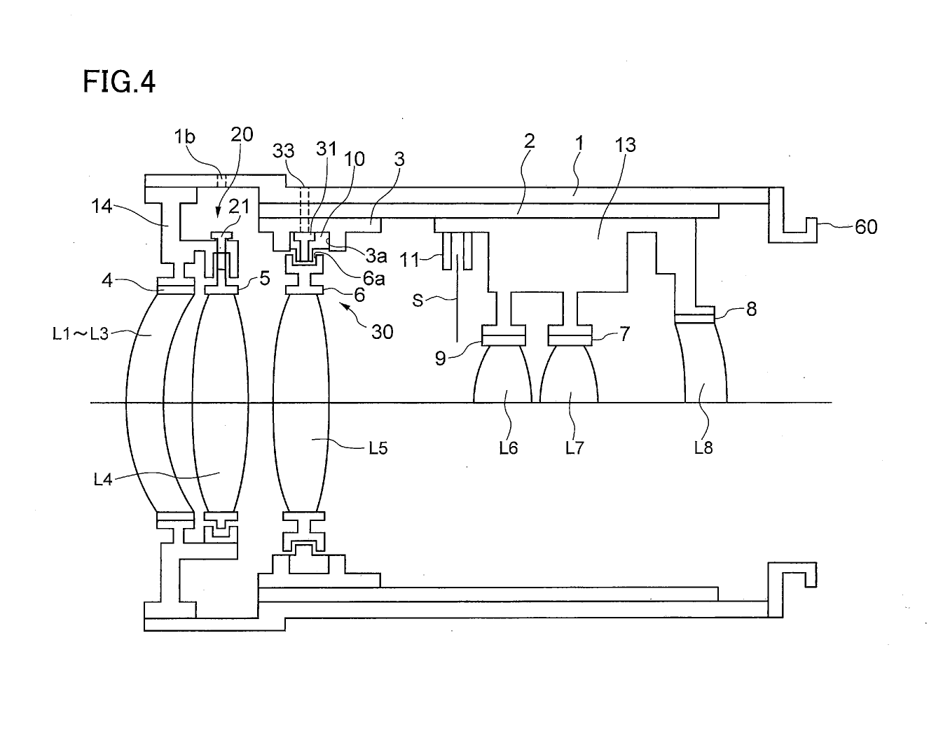

FIG. 4 is a view schematically showing a configuration of the variable focal length lens relating to the first Example, from a cross section.

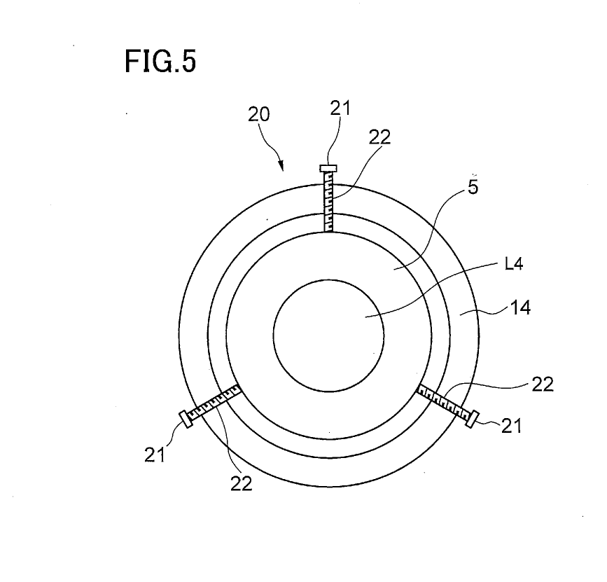

FIG. 5 is a view showing an adjustment mechanism 20 which performs a position adjustment for making shift decentering of the positive lens L4 on the most image side in the first lens group G1 of the variable focal length lens shown in FIG. 4, and it is a drawing viewed from the object side.

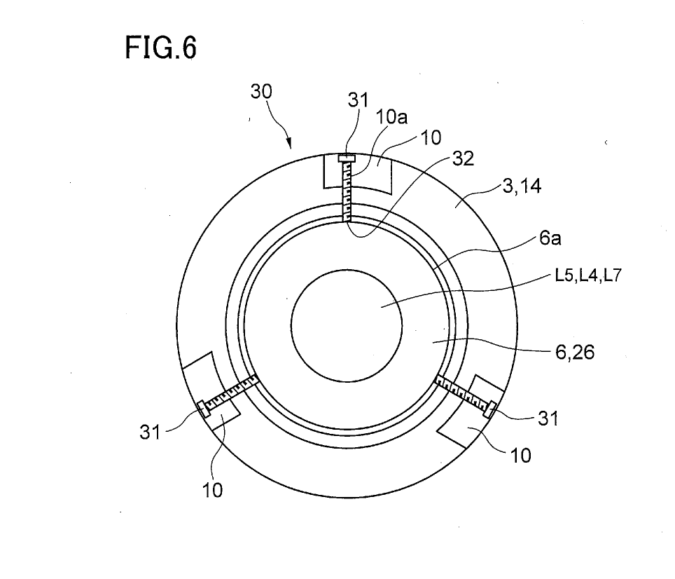

FIG. 6 is a view showing an adjustment mechanism 30 which performs a position adjustment for making tilt decentering of the lens group L5 on the most object side in the second lens group G2 of the variable focal length lens shown in FIG. 4, and it is a drawing viewed from the object side.

As shown in FIG. 4, a lens group L1-L3 of the first lens group G1 is held by a generally cylindrical holding member 4, the positive meniscus lens L4 of the first lens group G1 is held by a generally cylindrical holding member 5, the lens group L5 of the second lens group G2 is held by a generally cylindrical holding member 6, the iris stop S is held by a stop mechanism material 11, the lens group L6 of the second lens group G2 is held by a generally cylindrical holding member 9, the lens group L7 of the second lens group G2 is held by a generally cylindrical holding member 7, and the lens group L8 of the second lens group G2 is held by a generally cylindrical holding member 8.

The holding member 4 is fixed on an annular sliding member 14, the holding member 5 is fixed on the sliding member 14 by a screw 21 of the adjusting mechanism 20 as detailed later, and the sliding member 14 is movable on the optical axis by a fixed barrel 1. Further, the iris stop S is opened and closed by a stop mechanism 11.

The holding member 6 is held by a holding member 10 rotatably held in a recess 3a formed toward an inside of a lens barrel of a sliding member 3 slidably held on a cam barrel 2, and the holding members 7, 8, 9, 11 are held on a sliding member 13 slidably held on the cam barrel 2.

Cam pins (not shown) arranged in the sliding members 3, 13 are engaged with cam grooves (not shown) arranged in the cam barrel 2, whereby the sliding members 3, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

FIG. 5 is a view schematically showing the adjustment mechanism 20 which movably holds the positive meniscus lens L4 of the first lens group G1 in a direction orthogonal to the optical axis, and it is a drawing viewed from the object side.

As shown in FIGS. 4 and 5, the adjustment mechanism 20 has the holding member 14 where three screw holes 22 are arranged at a generally equal central angle such as 120° respectively and formed so that the screws 21 are screwed into the screw holes respectively.

As shown in FIG. 4, the fixed barrel 1 and the cam barrel 2 are provided with three through holes 1b to enable a rotating operation of the screws 21, so that a screw driver can be inserted into the through holes 1b to rotate the screws 21.

As shown in FIG. 5, the adjustment mechanism 20 can move the holding member 5 in a direction orthogonal to the optical axis and fix it, by pushing/pulling the screws 21, 21, 21 fastened in the screw holes 22, 22, 22 of the holding member 14. That is, the adjustment mechanism 20 can perform a position adjustment for making shift decentering of the lens L4 to the optical axis.

FIG. 6 is a view schematically showing the adjustment mechanism 30 which slantably holds the lens group L5 of the second lens group G2 so as to include a component in a direction orthogonal to the optical axis, and it is a drawing viewed from the object side.

As shown in FIGS. 4 and 6, the adjustment mechanism 30 includes the generally columnar holding member 10 rotatably held in the recess 3a of the sliding member 3, a screw hole 10a formed at a position deviated from a central position of the columnar holding member 10, a screw 31 screwed in the screw hole 10a, which has a length of a degree permitting the screw 31 to abut on the holding member 6 and hold the holding member 6 upon the end of screwing of the screw, and a recess 6a formed on an outer peripheral part of the holding member 6 to abut on an end part of the screw 31. The holding member 10 and the screws 31 are arranged at a generally equal central angle such as 120° in three locations.

In the adjustment mechanism 30, the screw 31 has a length of a degree permitting the screw to abut on the holding member 6 and hold the holding member 6 upon the end of screwing of the screw, so that when the screw 31 already screwed is further rotated, the columnar holding member 10 is rotated in the recess 3a of the sliding member 3 as the screw is rotated.

Since the position of the screw 31 is deviated from a center of the holding member 10, an end portion 32 of the screw 31 is moved drawing a predetermined circular track as the screw is rotated. In this time, the end portion 32 of the screw 31 contacts with a wall portion of the recess 6a of the holding member 6, so that it is possible to move the recess 6a in a direction along the optical axis.

With above-mentioned configuration, by driving the screw 31 to rotate the holding member 10, the holding member 6 can be made tilt to the optical axis, so that it is possible to perform a position adjustment for making tilt decentering of the lens 5 held by the holding member 6 to the optical axis.

As shown in FIG. 4, the sliding member 3, the cam barrel 2 and the fixed barrel 1 are provided with three through holes 33 to enable a rotating operation of the screws 31, so that a screwdriver can be inserted into the through holes 33 to rotate the screws 31.

In this way, in the variable focal length lens of the present application, by the adjustment mechanism 20, it is possible to conduct a position adjustment for making shift decentering of the positive meniscus lens L4 of the first lens group G1, and by the adjustment mechanism 30, it is possible to conduct a position adjustment for making tilt decentering of the lens group L5 of the second lens group G2.

Table 2 below shows values corresponding to the respective conditional expressions (1) to (4) in the variable focal length lens relating to the first Example.

TABLE 2
(Values for Conditional Expression)

| | |
|---|---|
| (1) | 2.83 |
| (2) | −5.15 |
| (3) | 2.83 |
| (4) | −5.15 |

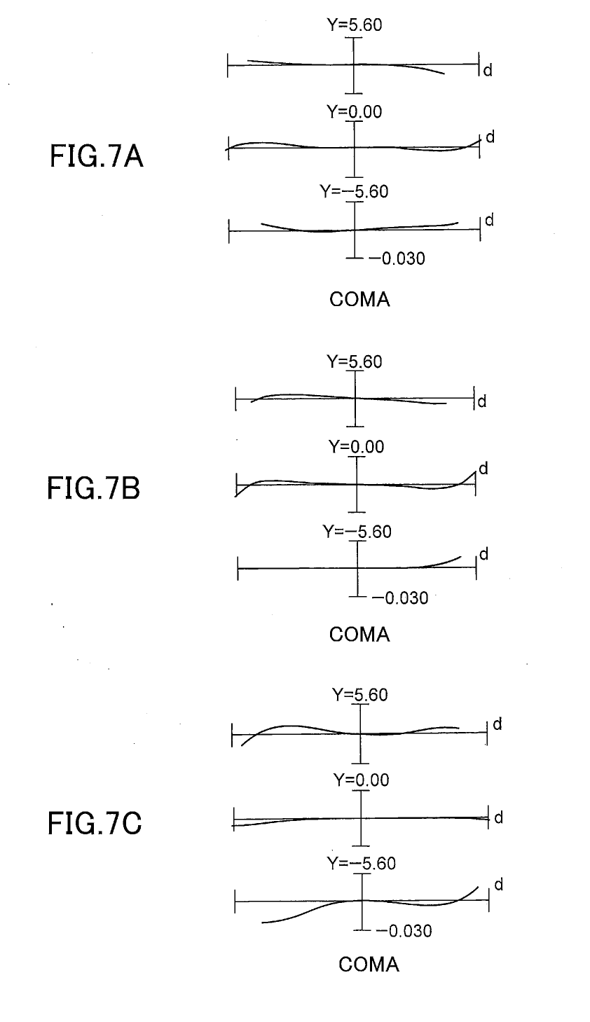

FIGS. 7A, 7B and 7C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making shift decentering of the positive meniscus lens L4 of the first lens group G1 by means of the adjustment mechanism 20 and by performing a position adjustment for making tilt decentering of the lens group L5 of the second lens group G2 by means of the adjustment mechanism 30, and FIGS. 7A, 7B and 7C indicate the wide angle end state, the intermediate focal length state, and the telephoto end state, respectively.

As seen from the comparison of diagrams of coma aberrations shown in FIGS. 7A, 7B and 7C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 7A, 7B and 7C.

### Second Example

The adjustment mechanism of the variable focal length lens relating to the second Example of the present application is explained with reference to the accompanying drawings. In the second Example, so as to satisfactorily correct deterioration of an imaging performance owing to decentering error in the manufacture, there are provided an adjustment mechanism 20 to perform a position adjustment for making shift decentering of the positive meniscus lens L4 on the most image side in the first lens group G1 and an adjustment mechanism 30 to perform a position adjustment for making tilt decentering of the lens group L7 as a partial lens group of the second lens group G2, and there is provided a configuration which enables vibration reduction by making shift decentering of the lens group L7.

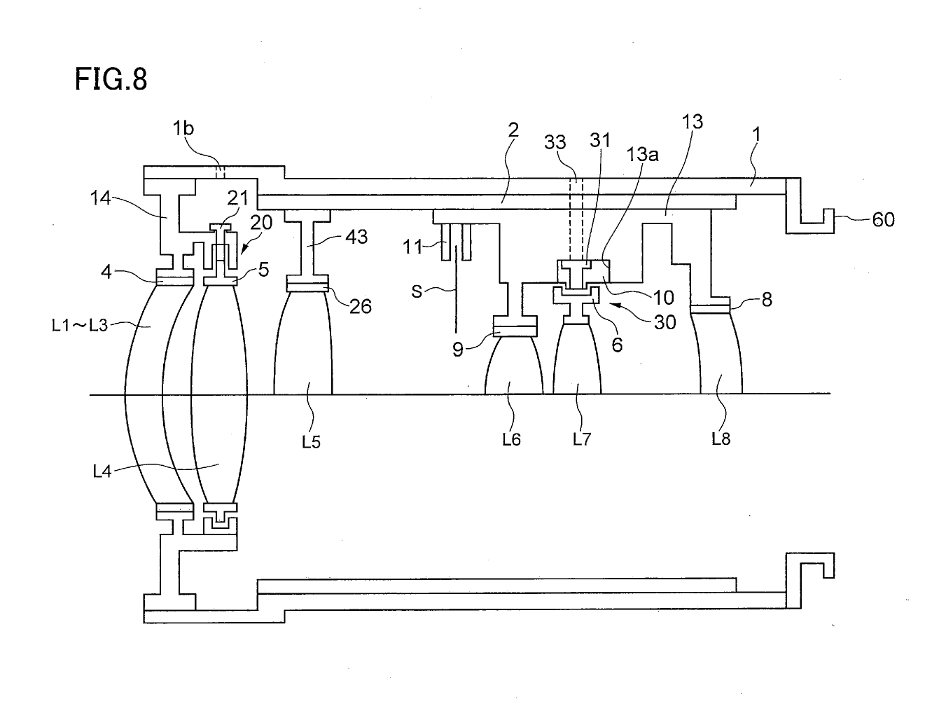

FIG. 8 is a view schematically showing a cross section of a configuration of the variable focal length lens relating to the second Example. In addition, portions having the same structures as those used in the first Example are described using the same symbols, or the same symbols are shown on the drawings with the details omitted.

As shown in FIG. 8, a lens group L1-L3 as a part of the first lens group G1 is held by a generally cylindrical holding member 4, the positive meniscus lens L4 of the first lens group G1 is held by a generally cylindrical holding member 5, the lens group L5 of the second lens group G2 is held by a generally cylindrical holding member 26, the iris stop S is held by a stop mechanism material 11, the lens group L6 of the second lens group G2 is held by a generally cylindrical holding member 9, the lens group L7 of the second lens group G2 is held by a generally cylindrical holding member 6, and the lens group L8 of the second lens group G2 is held by a generally cylindrical holding member 8.

The holding member 4 is fixed on an annular sliding member 14, the holding member 5 is fixed on the sliding member 14 by a screw 21 of the adjusting mechanism 20, and the sliding member 14 is movable on the optical axis by a fixed barrel 1. Further, the iris stop S is opened and closed by a stop mechanism 11.

The holding member 26 is held on a sliding member 43 slidably held on a cam barrel 2, the holding member 6 is held by a holding member 10 rotatably held in a recess 3a formed toward an inside of a lens barrel of a sliding member 13 slidably held on the cam barrel 2, and the holding members 6, 8, 9, 11 and the stop mechanism 11 are held on the sliding member 13 slidably held on the cam barrel 2.

Cam pins (not shown) arranged in the sliding member 43 and the sliding member 13 are engaged with cam grooves (not shown) arranged in the cam barrel 2, whereby the sliding member 43 and the sliding member 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

The adjustment mechanism 20 which performs a position adjustment of the positive meniscus lens L4 of the first lens group G1, is the same as that in the first Example as shown in FIG. 5, so that the details of configuration and operation of the adjustment mechanism are omitted.

Thus, in the variable focal length lens relating to the second Example of the present application, through the adjustment by the adjustment mechanism 20, it is possible to perform a position adjustment for making shift decentering of the positive meniscus lens L4 of the first lens group G1 to the optical axis.

Also, the adjustment mechanism 30 which performs a position adjustment of the lens group L7 of the second lens group G2 to make tilt decentering of the lens group L7 to the optical axis, is the same as that in the first Example as shown in FIG. 6, so that the details of configuration and operation of the adjustment mechanism are omitted.

Thus, in the variable focal length lens relating to the second Example of the present application, through the adjustment by the adjustment mechanism 30, it is possible to perform a position adjustment for making tilt decentering of the lens group L7 of the second lens group G2 to the optical axis. Further, the fixed barrel 1, the cam barrel 2 and the sliding member 13 are provided with three through holes 33 to enable a rotating operation of screws 21 of the adjustment mechanism 30, so that a screw driver can be inserted into the through holes 33 to rotate the screws 21.

In this way, in the variable focal length lens relating to the second Example of the present application, by the adjustment mechanism 20, it is possible to conduct a position adjustment for making shift decentering of the positive meniscus lens L4 of the first lens group G1, and by the adjustment mechanism 30, it is possible to conduct a position adjustment for making tilt decentering of the lens group L7 of the second lens group G2.

Further, the variable focal length lens relating to the second Example of the present application is provided with a publicly known vibration reduction mechanism which enables vibration reduction by making shift decentering of the lens group L7, whereby it is possible to satisfactorily correct deterioration of an imaging performance owing to optical axis deviation occurring at photographing caused by a camera shake or the like, in the entire focal length range from the wide angle end state to the telephoto end state.

Table 3 below shows values corresponding to the respective conditional expressions (1), (2), (5) and (6) in the variable focal length lens relating to the second Example.

TABLE 3
(Values for Conditional Expression)

| | |
|---|---|
| (1) | 2.83 |
| (2) | 1.36 |
| (5) | 2.83 |
| (6) | 1.36 |

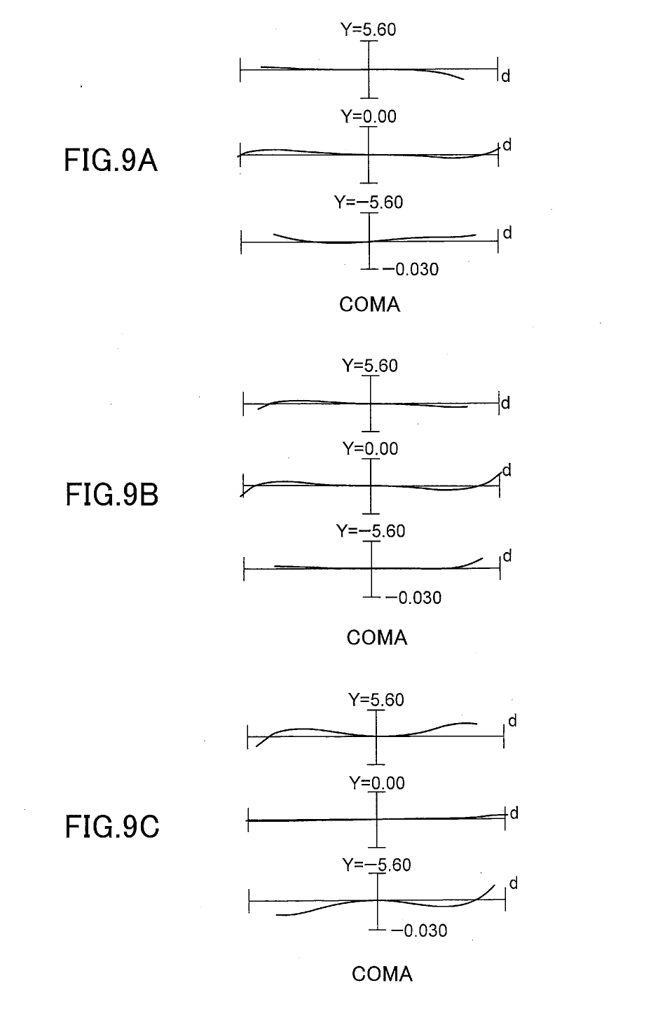

FIGS. 9A, 9B and 9C show diagrams of coma aberrations for d-line (wavelength λ=587.6 nm) in the infinite focusing state of the variable focal length lens relating to the second Example, when, in the case of occurrence of decentering error in the manufacture, decentering aberration is corrected by performing a position adjustment for making shift decentering of the positive meniscus lens L4 of the first lens group G1 by means of the adjustment mechanism 20 and by performing a position adjustment for making tilt decentering of the lens group L7 of the second lens group G2 by means of the adjustment mechanism 30, and FIGS. 9A, 9B and 9C indicate the wide angle end state, the intermediate focal length state, and the telephoto end state, respectively.

As seen from the comparison of diagrams of coma aberrations shown in FIGS. 9A, 9B and 9C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 9A, 9B and 9C.

### Third Example

The adjustment mechanism of the variable focal length lens relating to the third Example of the present application is explained. In the third Example, so as to satisfactorily correct deterioration of an imaging performance owing to decentering error in the manufacture, there are provided an adjustment mechanism 20 to perform a position adjustment for making shift decentering of the positive meniscus lens L4 on the most image side in the first lens group and an adjustment mechanism 40 to perform a position adjustment for making shift decentering of a vibration reduction lens group of the second lens group, for example, the negative lens group L8 positioned on the image side of the lens group L5.

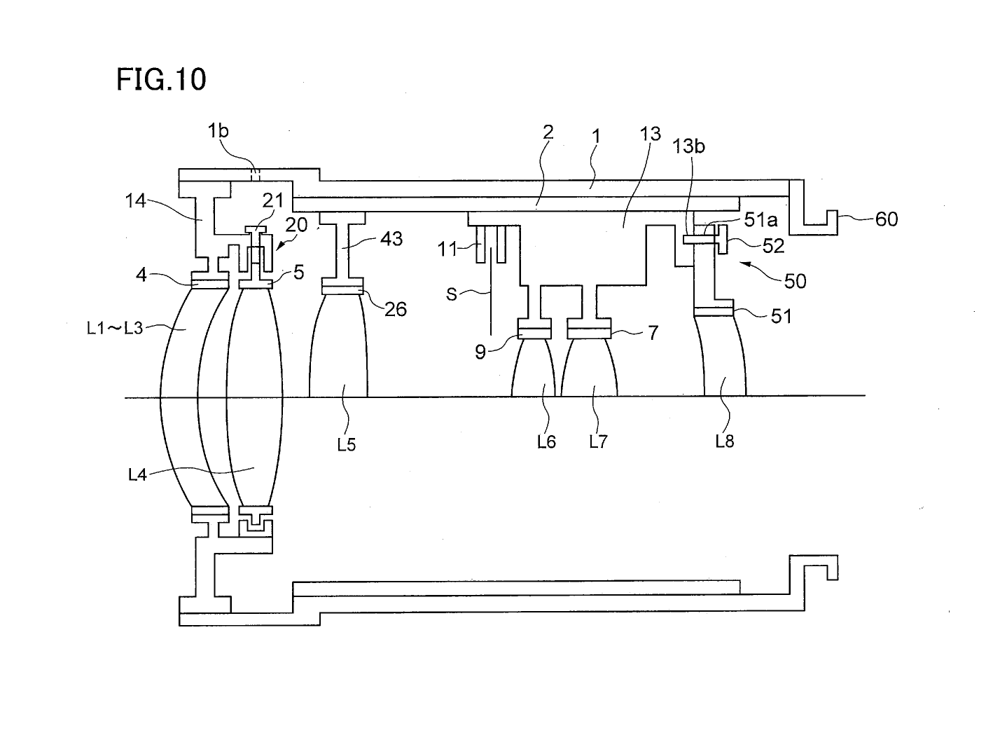

FIG. 10 is a view schematically showing a cross section of a configuration of the variable focal length lens relating to the third Example. In addition, portions having the same structures as those used in the first Example are described using the same symbols, or the same symbols are shown on the drawings with the details omitted.

As shown in FIG. 10, a lens group L1-L3 as a part of the first lens group G1 is held by a generally cylindrical holding member 4, the positive meniscus lens L4 of the first lens group G1 is held by a generally cylindrical holding member 5, the lens group L5 of the second lens group G2 is held by a generally cylindrical holding member 26, the iris stop S is held by a stop mechanism material 11, the lens group L6 of the second lens group G2 is held by a generally cylindrical holding member 9, the lens group L7 of the second lens group G2 is held by a generally cylindrical holding member 7, and the lens group L8 of the second lens group G2 is held by a generally cylindrical holding member 51.

The holding member 4 is fixed on an annular sliding member 14, the holding member 5 is fixed on the sliding member 14, and the sliding member 14 is movable on the optical axis by a fixed barrel 1. Further, the iris stop S is opened and closed by a stop mechanism 11.

The holding member 26 is held on a sliding member 43 slidably held on a cam barrel 2, and the holding members 7, 9 and the stop mechanism 11 are held on a sliding member 13 slidably held on the cam barrel 2. Further, the holding member 51 is fixed to the sliding member 13 slidably held on the cam barrel 2, by screws 52.

Cam pins (not shown) arranged in the sliding members 43, 13 are engaged with cam grooves (not shown) arranged in the cam barrel 2, whereby the sliding members 43, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

The adjustment mechanism 20 which performs a position adjustment of the positive meniscus lens L4 of the first lens group G1, is the same as that in the first Example as shown in FIG. 5, so that the details of configuration and operation of the adjustment mechanism are omitted.

Thus, in the variable focal length lens relating to the third Example of the present application, through the adjustment by the adjustment mechanism 20, it is possible to perform a position adjustment for making shift decentering of the positive meniscus lens L4 of the first lens group G1 to the optical axis.

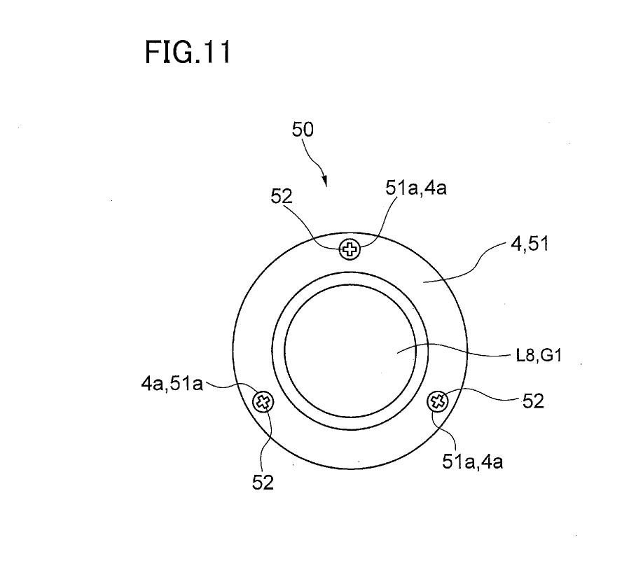

With reference to FIG. 11, there is explained the adjustment mechanism 50 which performs a position adjustment of the lens group L8 of the second lens group G2 to make shift decentering of the lens group L8 to the optical axis.

FIG. 11 is a view schematically showing the adjustment mechanism 50 viewed from the image surface side of the variable focal length lens. The holding member 51 is provided with three loose holes 51a, and the sliding member 13 is provided with three screw holes 13b corresponding to the loose holes 51a. A diameter of the loose hole 51a is made larger than a shaft diameter of the screw 52 and the screw hole of the sliding member 13 is so formed as to enable screwing of the screw 52. With this configuration, by tightening/releasing the three screws 52, it is possible to perform a position adjustment of the holding member 51 with respect to the sliding member 13 for adjusting the shift decentering and fixing it. That is, the adjustment mechanism 50 can perform a position adjustment for making shift decentering of the lens group L8 to the optical axis.

In this way, in the variable focal length lens of the present application, by the adjustment mechanism 20, it is possible to conduct a position adjustment for making shift decentering of the positive meniscus lens L4 of the first lens group G1, and by the adjustment mechanism 50, it is possible to conduct a position adjustment for making shift decentering of the lens group L8 of the second lens group G2.

Further, the variable focal length lens relating to the third Example of the present application is provided with a publicly known vibration reduction mechanism which enables vibration reduction by making shift decentering of the lens group L5 as an example, whereby it is possible to satisfactorily correct deterioration of an imaging performance owing to optical axis deviation occurring at photographing caused by a camera shake or the like, in the entire focal length range from the wide angle end state to the telephoto end state.

Table 4 below shows values corresponding to the respective conditional expressions (1), (2), (7) and (8) in the variable focal length lens relating to the third Example.

TABLE 4
(Values for Conditional Expression)

| | |
|---|---|
| (1) | 2.83 |
| (2) | 1.00 |
| (7) | 2.83 |
| (8) | 1.00 |

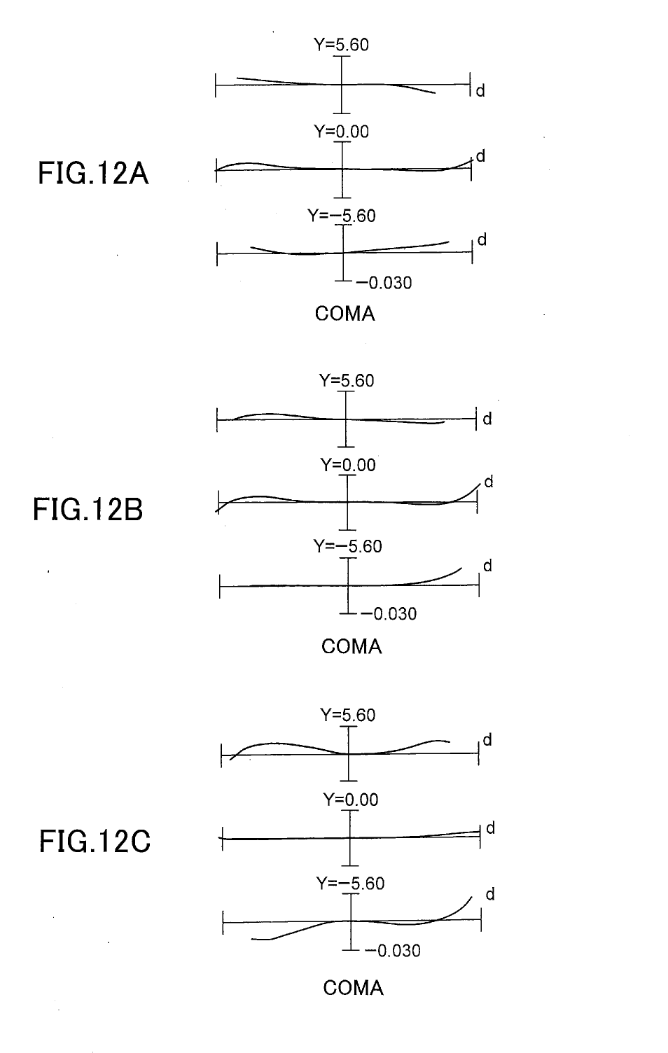

FIGS. 12A, 12B and 12C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making shift decentering of the positive meniscus lens L4 of the first lens group G1 by means of the adjustment mechanism 20 and by performing a position adjustment for making shift decentering of the lens group L8 of the second lens group G2 by means of the adjustment mechanism 50, and FIGS. 12A, 12B and 12C indicate the wide angle end state, the intermediate focal length state, and the telephoto end state, respectively.

As seen from the comparison of diagrams of coma aberrations shown in FIGS. 12A, 12B and 12C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 12A, 12B and 12C.

### Fourth Example

The adjustment mechanism of the variable focal length lens relating to the fourth Example of the present application is explained with reference to the accompanying drawings. In the fourth Example, so as to satisfactorily correct deterioration of an imaging performance owing to decentering error in the manufacture, there are provided a position adjustment 20 to perform a position adjustment for making shift decentering of the positive meniscus lens L4 on the most image side in the first lens group G1 and an adjustment mechanism 55 to perform a position adjustment for making shift decentering of the positive meniscus lens L83 on the most image side in the lens group L8 of the second lens group G2.

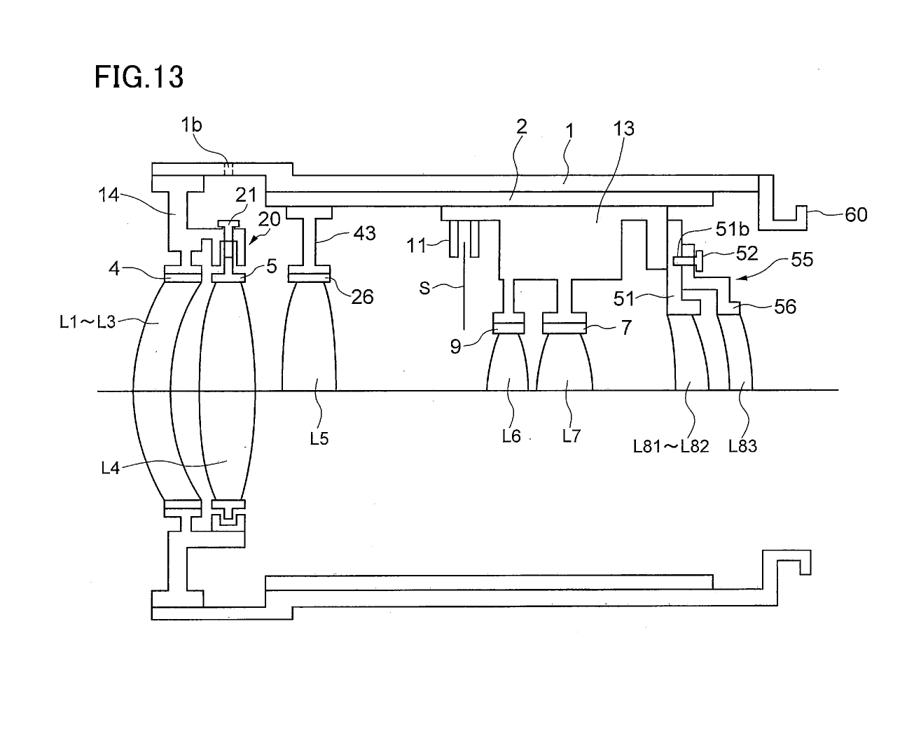

FIG. 13 is a view schematically showing a cross section of a configuration of the variable focal length lens relating to the fourth Example. In addition, portions having the same structures as those used in the first Example are described using the same symbols, or the same symbols are shown on the drawings with the details omitted.

As shown in FIG. 13, a lens group L1-L3 as a part of the first lens group G1 is held by a generally cylindrical holding member 4, the positive meniscus lens L4 of the first lens group G1 is held by a generally cylindrical holding member 5, the lens group L5 of the second lens group G2 is held by a generally cylindrical holding member 26, the iris stop S is held by a stop mechanism material 11, the lens group L6 of the second lens group G2 is held by a generally cylindrical holding member 9, the lens group L7 of the second lens group G2 is held by a generally cylindrical holding member 7, a lens group L81, L82 as a part of the lens group L8 of the second lens group G2 is held by a generally cylindrical holding member 51, and the positive meniscus lens L83 on the most image side in the lens group L8 of the second lens group G2 is held by a generally cylindrical holding member 56.

The holding member 4 is fixed on an annular sliding member 14, the holding member 5 generally is fixed on the sliding member 14, and the sliding member 14 is movable on the optical axis by a fixed barrel 1. Further, the iris stop S is opened and closed by a stop mechanism 11.

The holding member 26 is held on a sliding member 43 slidably held on a cam barrel 2, the holding members 7, 9 and the stop mechanism 11 are held on the sliding member 13 slidably held on the cam barrel 2, and the holding member 51 is held on the sliding member 13 slidably held on the cam barrel 2. Further, the holding member 56 is fixed to the holding member 51 by screws 52.

Cam pins (not shown) arranged in the sliding members 43, 13 are engaged with cam grooves (not shown) arranged in the cam barrel 2, whereby the sliding members 43, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

The adjustment mechanism 20 which performs a position adjustment of the positive meniscus lens L4 of the first lens group G1, is the same as that in the first Example as shown in FIG. 5, so that the details of configuration and operation of the adjustment mechanism are omitted.

Thus, in the variable focal length lens relating to the fourth Example of the present application, through the adjustment by the adjustment mechanism 20, it is possible to perform a position adjustment for making shift decentering of the positive meniscus lens L4 of the first lens group G1 to the optical axis.

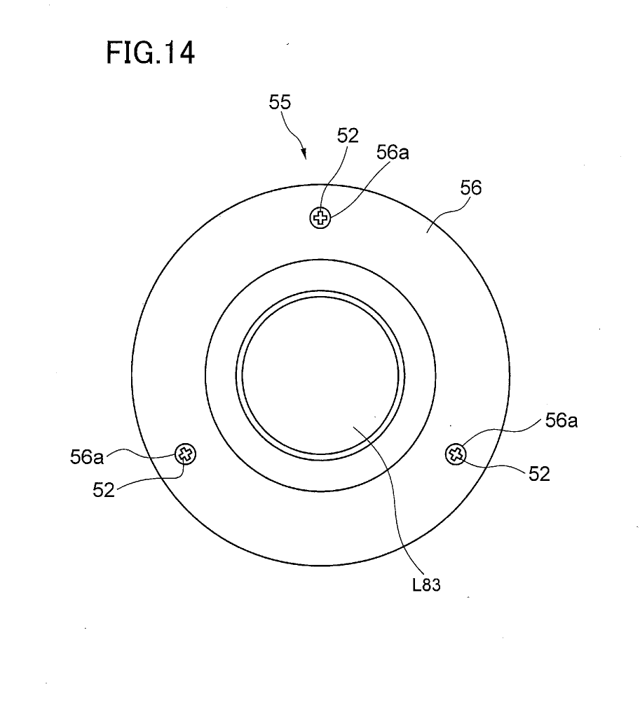

With reference to FIG. 14, there is explained the adjustment mechanism 55 which performs a position adjustment of the positive meniscus lens L83 on the most image side in the lens group L8 of the second lens group G2 to make shift decentering of the lens group L83 to the optical axis.

FIG. 14 is a view schematically showing the adjustment mechanism 55 viewed from the image surface side of the variable focal length lens. The adjustment mechanism 55 is almost the same as the adjustment mechanism 50 shown in FIG. 11, but a shape of a part of member thereof is changed to be generally L-shaped in cross section as shown in FIG. 13 so as to avoid interference of the positive meniscus lens L83 with the other lens group L81, L82 of the lens group L8. The holding member 56 is provided with three loose holes 56a, and the holding member 51 is provided with three screw holes 51b corresponding to the loose holes 56a. A diameter of the loose hole 56a is made larger than a shaft diameter of the screw 52 and the screw hole of the holding member 51 is so formed as to enable screwing of the screw 52. With this configuration, by tightening/releasing the three screws 52, it is possible to perform a position adjustment of the holding member 56 with respect to the holding member 51 for adjusting the shift decentering and fixing it. That is, the adjustment mechanism 55 can perform a position adjustment for making shift decentering of the positive meniscus lens L83 to the optical axis.

In this way, in the variable focal length lens of the present application, by the adjustment mechanism 20, it is possible to conduct a position adjustment for making shift decentering of the positive meniscus lens L4 of the first lens group G1, and by the adjustment mechanism 55, it is possible to conduct a position adjustment for making shift decentering of the positive meniscus lens L83 on the most image side in the lens group L8 of the second lens group G2.

Table 5 below shows values corresponding to the respective conditional expressions (1), (2) and (9) in the variable focal length lens relating to the fourth Example.

TABLE 5
(Values for Conditional Expression)

| | |
|---|---|
| (1) | 2.83 |
| (2) | 1.00 |
| (9) | 2.83 |

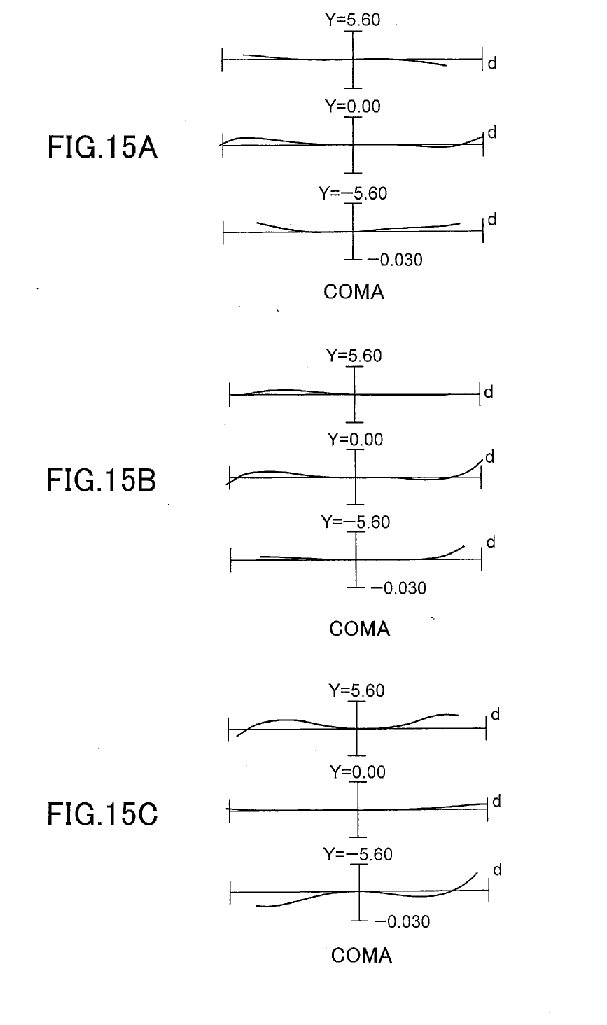

FIGS. 15A, 15B and 15C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making shift decentering of the positive meniscus lens L4 of the first lens group G1 by means of the adjustment mechanism 20 and by performing a position adjustment for making shift decentering of the positive meniscus lens L83 on the most image side in the second lens group G2 by means of the adjustment mechanism 55, and FIGS. 15A, 15B and 15C indicate the wide angle end state, the intermediate focal length state, and the telephoto end state, respectively.

As seen from the comparison of diagrams of coma aberrations shown in FIGS. 15A, 15B and 15C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 15A, 15B and 15C.

### Fifth Example

The adjustment mechanism of the variable focal length lens relating to the fifth Example of the present application is explained with reference to the accompanying drawings. In the fifth Example, so as to satisfactorily correct deterioration of an imaging performance owing to decentering error in the manufacture, there are provided an adjustment mechanism 50 to perform a position adjustment for making tilt decentering of the first lens group G1 and an adjustment mechanism 50 to perform a position adjustment for making shift decentering of a vibration reduction lens group of the second lens group, for example, the negative lens group L8 positioned on the image side of the lens group L5.

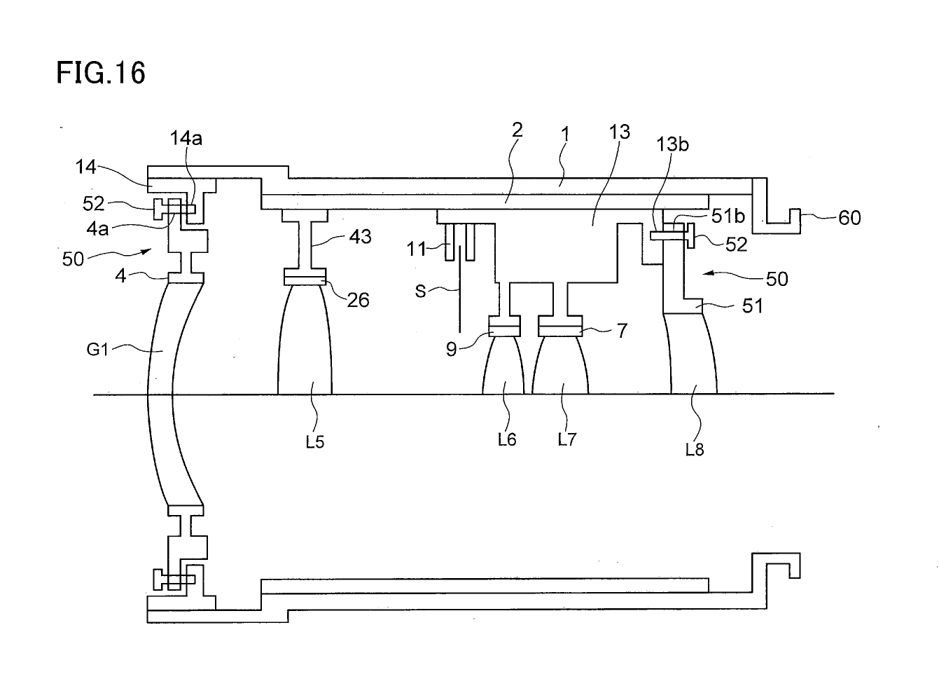

FIG. 16 is a view schematically showing a cross section of a configuration of the variable focal length lens relating to the fifth Example. In addition, portions having the same structures as those used in the third Example are described using the same symbols, or the same symbols are shown on the drawings with the details omitted.

As shown in FIG. 16, the first lens group G1 is held by a generally cylindrical holding member 4, the lens group L5 of the second lens group G2 is held by a generally cylindrical holding member 26, the iris stop S is held by a stop mechanism material 11, the lens group L6 of the second lens group G2 is held by a generally cylindrical holding member 9, the lens group L7 of the second lens group G2 is held by a generally cylindrical holding member 7, and the lens group L8 of the second lens group G2 is held by a generally cylindrical holding member 51.

The holding member 4 is fixed on an annular sliding member 14 by screws 52, and the sliding member 14 is movable on the optical axis by a fixed barrel 1. Further, the iris stop S is opened and closed by a stop mechanism 11.

The holding member 26 is held on a sliding member 43 slidably held on a cam barrel 2, and the holding members 7, 9 and the stop mechanism 11 are held on a sliding member 13 slidably held on the cam barrel 2. Further, the holding member 51 is fixed to the sliding member 13 slidably held on the cam barrel 2, by screws 52.

Cam pins (not shown) arranged in the sliding members 43, 13 are engaged with cam grooves (not shown) arranged in the cam barrel 2, whereby the sliding members 43, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

In the variable focal length lens of the present application, through the adjustment by the adjustment mechanism 50, it is possible to perform a position adjustment for making tilt decentering of the first lens group G1 to the optical axis and a position adjustment for making shift decentering of the lens group L8 of the second lens group G2 to the optical axis.

A position adjustment, by the adjustment mechanism 50, for making shift decentering of the lens group L8 of the second lens group G2 to the optical axis is the same as that in the third Example, so that the details of this position adjustment are omitted.

A position adjustment, by the adjustment mechanism 50, for making tilt decentering of the first lens group G1 to the optical axis is explained with reference to FIGS. 11 and 16.

FIG. 11 is a view schematically showing the adjustment mechanism 50 viewed from the object side of the variable focal length lens. The holding member 4 is provided with three loose holes 4a, and the holding member 14 is provided with three screw holes 14b corresponding to the loose holes 4a. A diameter of the loose hole 4a is made larger than a shaft diameter of the screw 52 and the screw hole of the holding member 14 is so formed as to enable screwing of the screw 52. With this configuration, by tightening and fastening one of the three screws 52 and tightening/releasing the other two screws 52, it is possible to adjust a tilt of the holding member 4 with respect to the holding member 14 and fix it. That is, the adjustment mechanism 50 can perform a position adjustment for making tilt decentering of the lens group G1 to the optical axis.

In this way, in the variable focal length lens of the present application, by the adjustment mechanism 50, it is possible to conduct a position adjustment for making tilt decentering of the first lens group G1, and by the adjustment mechanism 50, it is possible to conduct a position adjustment for making shift decentering of the lens group L8 of the second lens group G2. In addition, the adjustment mechanism 50 is so configured that the position adjustment can be employed for both of shift and tilt by adjustment of fastening/tightening of the three screws 52.

Further, the variable focal length lens relating to the fifth Example of the present application is provided with a publicly known vibration reduction mechanism which enables vibration reduction by making shift decentering of the lens group L5 as an example, whereby it is possible to satisfactorily correct deterioration of an imaging performance owing to optical axis deviation occurring at photographing caused by a camera shake or the like, in the entire focal length range from the wide angle end state to the telephoto end state.

Table 6 below shows values corresponding to the respective conditional expressions (1), (2), (10) and (11) in the variable focal length lens relating to the fifth Example.

TABLE 6
(Values for Conditional Expression)

| | |
|---|---|
| (1) | 2.83 |
| (2) | 1.00 |
| (10) | 2.83 |
| (11) | 1.00 |

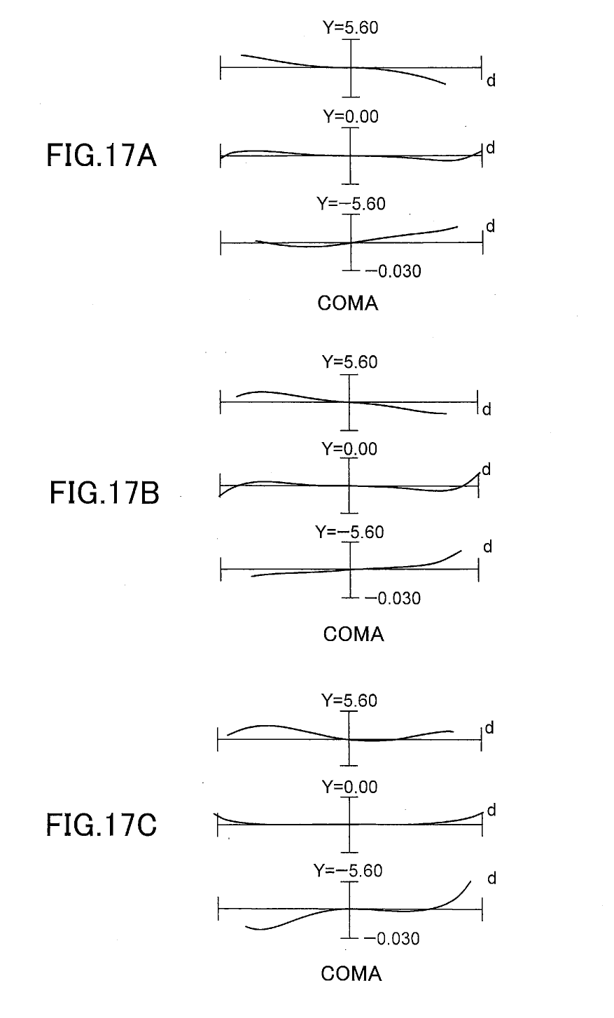

FIGS. 17A, 17B and 17C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making tilt decentering of the first lens group G1 by means of the adjustment mechanism 50 and by performing a position adjustment for making shift decentering of the lens group L8 of the second lens group G2 by means of the adjustment mechanism. 50, and FIGS. 17A, 17B and 17C indicate the wide angle end state, the intermediate focal length state, and the telephoto end state, respectively.

As seen from the comparison of diagrams of coma aberrations shown in FIGS. 17A, 17B and 17C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 17A, 17B and 17C.

### Sixth Example

The adjustment mechanism of the variable focal length lens relating to the sixth Example of the present application is explained with reference to the accompanying drawings. In the sixth Example, so as to satisfactorily correct deterioration of an imaging performance owing to decentering error in the manufacture, there is provided a structural mechanism capable of performing a position adjustment for making tilt decentering of the first lens group G1 and a position adjustment for making shift decentering of the positive meniscus lens L83 of the second lens group.

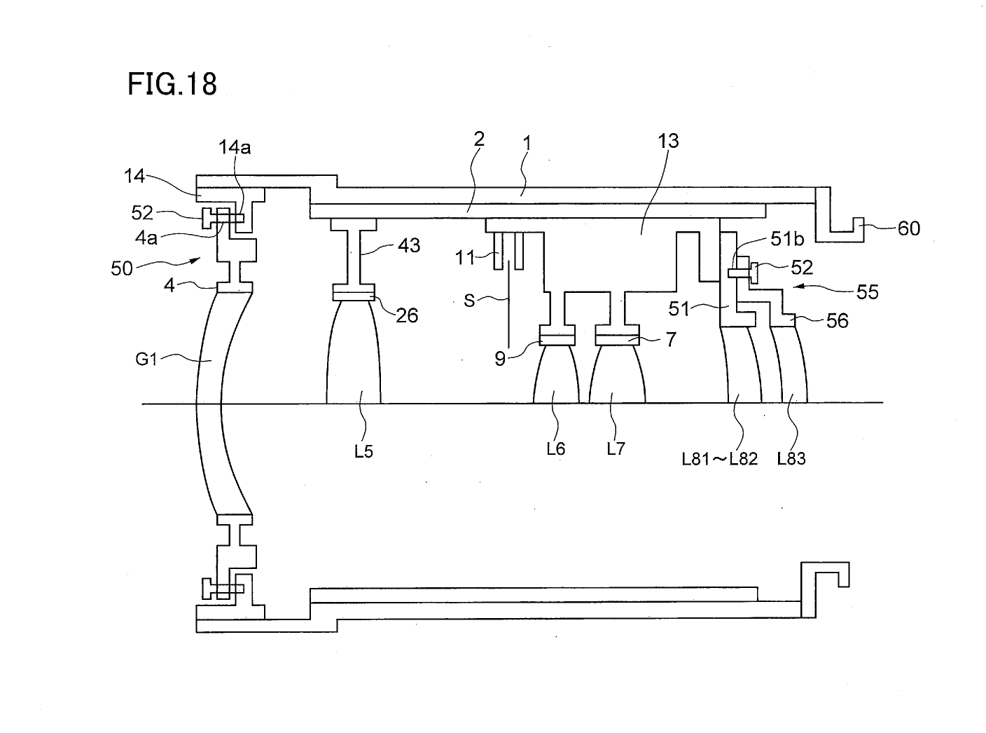

FIG. 18 is a view schematically showing a cross section of a configuration of the variable focal length lens relating to the sixth Example. In addition, portions having the same structures as those used in the fourth Example and the fifth Example are described using the same symbols, or the same symbols are shown on the drawings with the details omitted.

As shown in FIG. 18, the first lens group G1 is held by a generally cylindrical holding member 4, the lens group L5 of the second lens group G2 is held by a generally cylindrical holding member 26, the iris stop S is held by a stop mechanism material 11, the lens group L6 of the second lens group G2 is held by a generally cylindrical holding member 9, the lens group L7 of the second lens group G2 is held by a generally cylindrical holding member 7, a lens group L81, L82 as a part of the lens group L8 of the second lens group G2 is held by a generally cylindrical holding member 51, the positive meniscus lens L83 on the most image side in the lens group L8 of the second lens group G2 is held by a holding member 56.

The holding member 4 is fixed on an annular sliding member 14 by screws 52, and the sliding member 14 is movable on the optical axis by a fixed barrel 1. Further, the iris stop S is opened and closed by a stop mechanism 11.

The holding member 26 is held on a sliding member 43 slidably held on a cam barrel 2, the holding members 7, 9 and the stop mechanism 11 are held on a sliding member 13 slidably held on the cam barrel 2, and the holding member 51 is held on the sliding member 13 slidably held on the cam barrel 2. Further, the holding member 56 is fixed to the holding member 51 slidably held on the cam barrel 2, by the screws 52.

Cam pins (not shown) arranged in the sliding members 43, 13 are engaged with cam grooves (not shown) arranged in the cam barrel 2, whereby the sliding members 43, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

As shown in FIG. 18, an adjustment mechanism 50 in which the holding member 4 holding the first lens group G1 is fixed to the sliding member 14 and by which a position adjustment is made, is the same as that in the fifth Example as shown in FIG. 11, so that the details of configuration and operation of the adjustment mechanism are omitted. Additionally, it is possible to adjust a tilt of the holding member 4 with respect to the sliding member 4 and fix it, in the same manner as in the fifth Example. That is, in the variable focal length lens relating to the sixth Example of the present application, the adjustment mechanism 50 can perform a position adjustment for making tilt decentering of the first lens group G1 to the optical axis.

Further, as shown in FIG. 18, an adjustment mechanism 55 in which the holding member 56 holding the positive meniscus lens L83 on the most image side in the second lens group G2 is fixed to the holding member 51 and by which a position adjustment is made, is the same as that in the fourth Example as shown in FIG. 14, so that the details of configuration and operation of the adjustment mechanism are omitted. Additionally, it is possible to adjust a shift of the holding member 56 with respect to the holding member 51 and fix it, in the same manner as in the fourth Example. That is, in the variable focal length lens relating to the sixth Example of the present application, it is possible to perform a position adjustment for making shift decentering of the positive meniscus lens L83 on the most image side in the second lens group G2 to the optical axis.

In this way, in the variable focal length lens of the present application, by the adjustment mechanism 50, it is possible to conduct a position adjustment for making tilt decentering of the first lens group G1, and by the adjustment mechanism 55, it is possible to perform a position adjustment for making shift decentering of the positive meniscus lens L83 on the most image side in the second lens group G2.

Further, the variable focal length lens relating to the sixth Example of the present application is provided with a publicly known vibration reduction mechanism which enables vibration reduction by making shift decentering of the lens group L5 as an example, whereby it is possible to satisfactorily correct deterioration of an imaging performance owing to optical axis deviation occurring at photographing caused by a camera shake or the like, in the entire focal length range from the wide angle end state to the telephoto end state.

Table 7 below shows values corresponding to the respective conditional expressions (1), (2) and (12) in the variable focal length lens relating to the fifth Example.

TABLE 7
(Values for Conditional Expression)

| | |
|---|---|
| (1) | 2.83 |
| (2) | 1.00 |
| (12) | 2.83 |

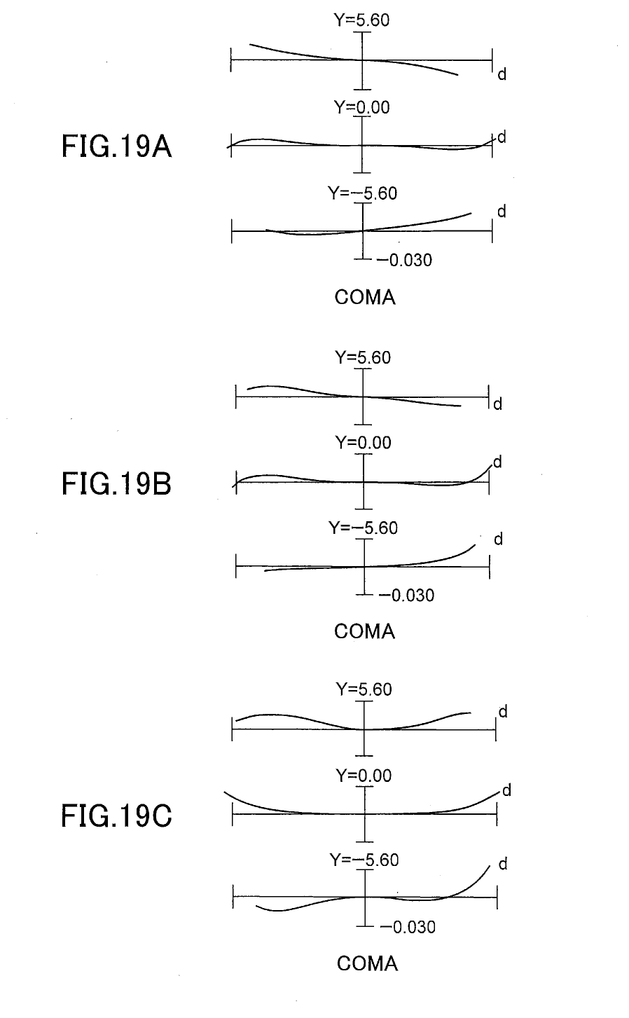

FIGS. 19A, 19B and 19C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making tilt decentering of the first lens group G1 by means of the adjustment mechanism 50 and by performing a position adjustment for making shift decentering of the positive meniscus lens L83 on the most image side in the second lens group G2 by means of the adjustment mechanism 55, and FIGS. 19A, 19B and 19C indicate the wide angle end state, the intermediate focal length state, and the telephoto end state, respectively.

As seen from the comparison of diagrams of coma aberrations shown in FIGS. 19A, 19B and 19C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 19A, 19B and 19C.

### Seventh Example

The adjustment mechanism of the variable focal length lens relating to the seventh Example of the present application is explained with reference to the accompanying drawings. In the seventh Example, so as to satisfactorily correct deterioration of an imaging performance owing to decentering error in the manufacture, there are provided an adjustment mechanism 30 to perform a position adjustment for making tilt decentering of the positive meniscus lens L4 on the most image side in the first lens group G1 and an adjustment mechanism 30 to perform a position adjustment for making tilt decentering of the lens group L5 on the most object side in the second lens group.

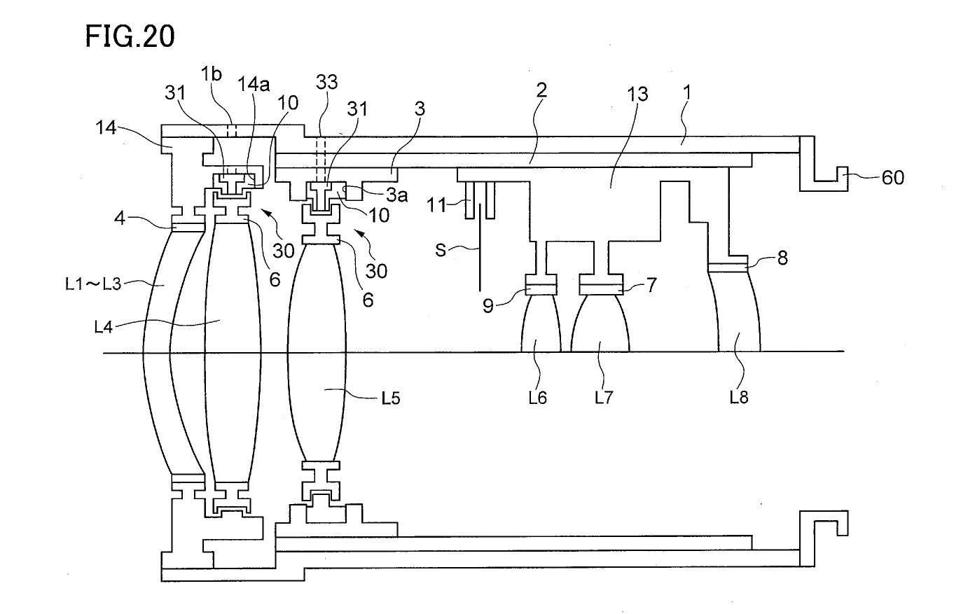

FIG. 20 is a view schematically showing a cross section of a configuration of the variable focal length lens relating to the seventh Example. In addition, portions having the same structures as those used in the first Example are described using the same symbols, or the same symbols are shown on the drawings with the details omitted.

As shown in FIG. 20, a lens group L1-L3 of the first lens group G1 is held by a generally cylindrical holding member 4, the positive meniscus lens L4 of the first lens group G1 is held by a generally cylindrical holding member 26, the lens group L5 of the second lens group G2 is held by a generally cylindrical holding member 6, the iris stop S is held by a stop mechanism material 11, the lens group L6 of the second lens group G2 is held by a generally cylindrical holding member 9, the lens group L7 of the second lens group G2 is held by a generally cylindrical holding member 7, and the lens group L8 of the second lens group G2 is held by a generally cylindrical holding member 8.

The holding member 4 is fixed on an annular sliding member 14, the holding member 26 is held by a holding member 10 rotatably held in a recess 14a of the sliding member 14, and the sliding member 14 is movable on the optical axis by a fixed barrel 1. Further, the iris stop S is opened and closed by a stop mechanism 11.

The holding member 6 is held by the holding member 10 rotatably held in a recess 3a of a sliding member 3 slidably held on a cam barrel 2, and the holding members 7, 8, 9, 11 are held on a sliding member 13 slidably held on the cam barrel 2.

Cam pins (not shown) arranged in the sliding members 3, 13 are engaged with cam grooves (not shown) arranged in the cam barrel 2, whereby the sliding members 3, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

As shown in FIG. 20, the adjustment mechanism. 30 in which the holding member 6 holding the positive meniscus lens L4 on the most image side in the first lens group G1 is fixed to the sliding member 14 and by which a position adjustment is made, is the same as that in the first Example as shown in FIG. 6, so that the details of configuration and operation of the adjustment mechanism are omitted. Additionally, it is possible to adjust a tilt of the holding member 4 with respect to the sliding member 14 and fix it, in the same manner as in the first Example. That is, in the variable focal length lens relating to the seventh Example of the present application, the adjustment mechanism 30 can perform a position adjustment for making tilt decentering of the positive meniscus lens L4 of the first lens group G1 to the optical axis.

Further, as shown in FIG. 20, the adjustment mechanism 30 in which the holding member 6 holding the lens group L5 on the most object side in the second lens group G2 is fixed to the sliding member 3 and by which a position adjustment is made, is the same as that in the first Example as shown in FIG. 6, so that the details of configuration and operation of the adjustment mechanism are omitted. Additionally, it is possible to adjust a tilt of the holding member 6 with respect to the sliding member 3, in the same manner as in the first Example. That is, in the variable focal length lens relating to the sixth Example of the present application, it is possible to perform a position adjustment for making tilt decentering of the lens group L5 on the most object side in the second lens group G2 to the optical axis.

In this way, in the variable focal length lens of the present application, by the adjustment mechanism 30, it is possible to conduct a position adjustment for making tilt decentering of the positive meniscus lens L4 of the first lens group G1, and by the adjustment mechanism 30, it is possible to conduct a position adjustment for making tilt decentering of the lens group L5 of the second lens group G2.

Table 8 below shows values corresponding to the respective conditional expressions (1), (2), (13) and (14) in the variable focal length lens relating to the seventh Example.

TABLE 8
(Values for Conditional Expression)

| | |
|---|---|
| (1) | 2.83 |
| (2) | −5.15 |
| (13) | 2.83 |
| (14) | −5.15 |

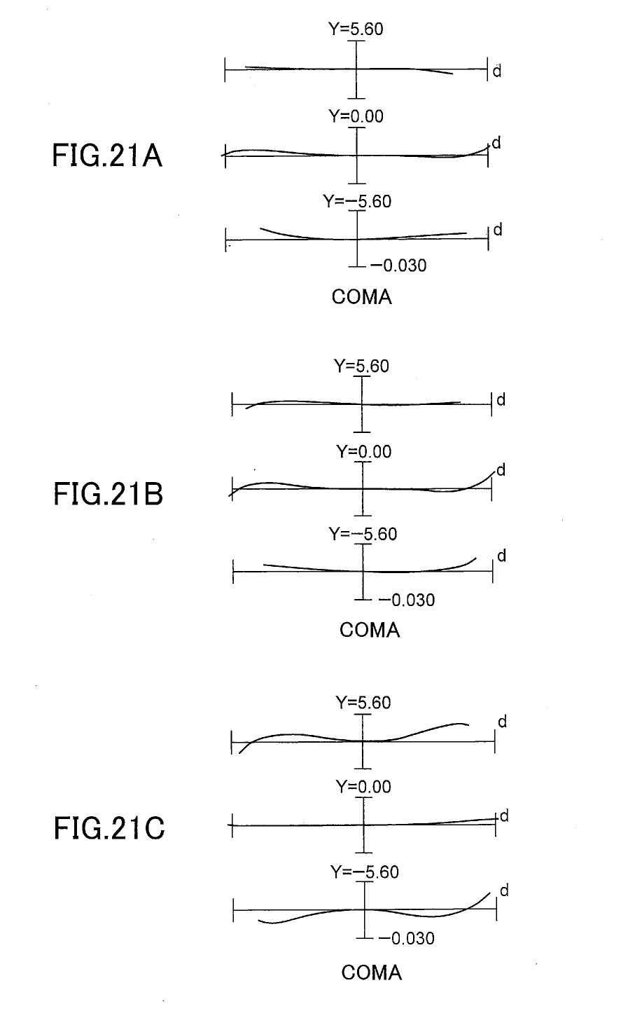

FIGS. 21A, 21B and 21C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making tilt decentering of the positive meniscus lens L4 of the first lens group G1 by means of the adjustment mechanism 30 and by performing a position adjustment for making tilt decentering of the lens group L5 of the second lens group G2 by means of the adjustment mechanism 30, and FIGS. 21A, 21B and 21C indicate the wide angle end state, the intermediate focal length state, and the telephoto end state, respectively.

As seen from the comparison of diagrams of coma aberrations shown in FIGS. 21A, 21B and 21C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 21A, 21B and 21C.

### Eighth Example

The adjustment mechanism of the variable focal length lens relating to the eighth Example of the present application is explained with reference to the accompanying drawings. In the eighth Example, so as to satisfactorily correct deterioration of an imaging performance owing to decentering error in the manufacture, there are provided an adjustment mechanism 30 to perform a position adjustment for making tilt decentering of the positive meniscus lens L4 on the most image side in the first lens group G1 and an adjustment mechanism 30 to perform a position adjustment for making tilt decentering of the lens group L7 of the second lens group G2, and there is a structural mechanism which enables vibration reduction by making shift decentering of the lens group L5 as an example.

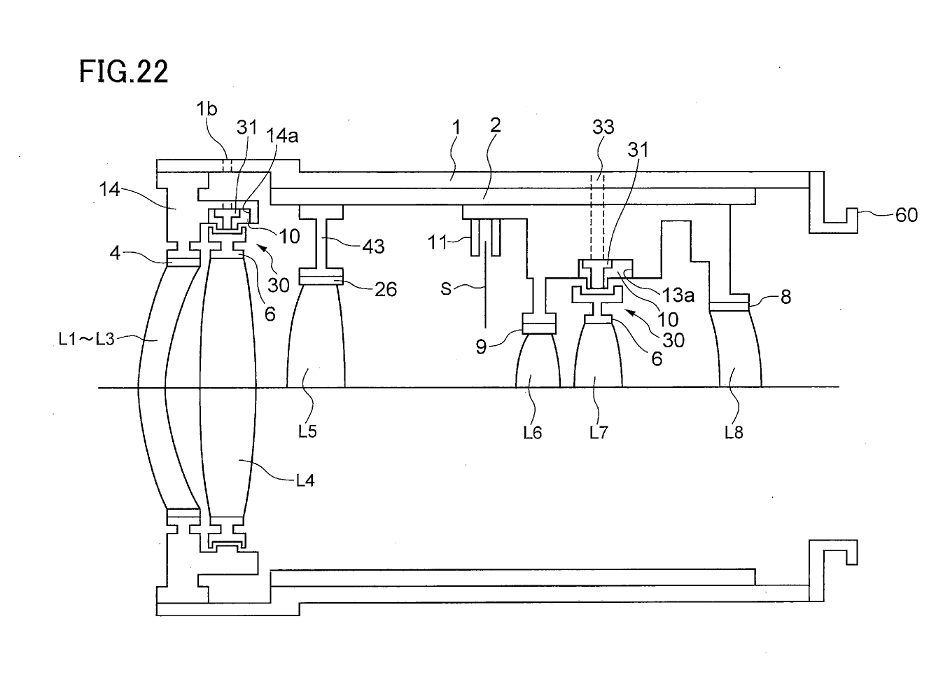

FIG. 22 is a view schematically showing a cross section of a configuration of the variable focal length lens relating to the eighth Example.

In addition, portions having the same structures as those used in the seventh Example and the second Example are described using the same symbols, or the same symbols are shown on the drawings with the details omitted.

As shown in FIG. 22, a lens group L1-L3 of the first lens group G1 is held by a generally cylindrical holding member 4, the positive meniscus lens L4 of the first lens group G1 is held by a generally cylindrical holding member 6, the lens group L5 of the second lens group G2 is held by a generally cylindrical holding member 26, the iris stop S is held by a stop mechanism material 11, the lens group L6 of the second lens group G2 is held by a generally cylindrical holding member 9, the lens group L7 of the second lens group G2 is held by a generally cylindrical holding member 7, and the lens group L8 of the second lens group G2 is held by a generally cylindrical holding member 8.

The holding member 4 is fixed on an annular sliding member 14, the holding member 6 is held by a holding member 10 rotatably held in a recess 14a of the sliding member 14, and the sliding member 14 is movable on the optical axis by a fixed barrel 1. Further, the iris stop S is opened and closed by a stop mechanism 11.

The holding member 26 is held on a sliding member 43 slidably held on a cam barrel 2, the holding member 6 is held by the holding member 10 rotatably held in a recess 13a formed toward an inside of a lens barrel of a sliding member 13 slidably held on the cam barrel 2, and the holding members 6, 8, 9, 11 and the stop mechanism 11 are held on the sliding member 13 slidably held on the cam barrel 2.

Cam pins (not shown) arranged in the sliding members 43, 13 are engaged with cam grooves (not shown) arranged in the cam barrel 2, whereby the sliding members 43, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

A configuration for holding on the sliding member 14 the holding member 16 holding the positive meniscus lens L4 on the most image side in the first lens group G1, as shown in FIG. 22, is the same as the adjustment mechanism 30 (FIGS. 6, 20) presented in the seventh Example, so that the details of configuration and operation of the adjustment mechanism are omitted. Additionally, it is possible to adjust a tilt of the fixing member 16 by rotation of the holding member 10 and then fix it, in the same manner as in the seventh Example. That is, the adjustment mechanism 30 can perform a position adjustment for making tilt decentering of the positive meniscus lens L4 to the optical axis.

Further, a configuration for holding on the sliding member 13 the holding member 6 holding the lens group L7 of the second lens group G2, as shown in FIG. 22, is the same as the adjustment mechanism 30 (see FIGS. 6, 8) presented in the second Example, so that the details of configuration and operation of the adjustment mechanism are omitted. Additionally, it is possible to adjust a tilt of the fixing member 7 by rotation of the holding member 10 and then fix it, in the same manner as in the second Example. That is, the adjustment mechanism 30 can perform a position adjustment for making tilt decentering of the lens group L7 of the second lens group G2 to the optical axis.

Thus, a position adjustment for making tilt decentering of the positive lens L4 and a position adjustment for making tilt decentering of the lens group L7 are conducted.

In this way, in the variable focal length lens of the present application, by the adjustment mechanism 30, it is possible to conduct a position adjustment for making tilt decentering of the positive meniscus lens L4 of the first lens group G1, and by the adjustment mechanism 30, it is possible to conduct a position adjustment for making tilt decentering of the lens group L7 of the second lens group G2.

Further, the variable focal length lens relating to the eighth Example of the present application is provided with a publicly known vibration reduction mechanism which enables vibration reduction by making shift decentering of the lens group L5 as an example, whereby it is possible to satisfactorily correct deterioration of an imaging performance owing to optical axis deviation occurring at photographing caused by a camera shake or the like, in the entire focal length range from the wide angle end state to the telephoto end state.

Table 9 below shows values corresponding to the respective conditional expressions (1), (2), (15) and (16) in the variable focal length lens relating to the eighth Example.

TABLE 9
(Values for Conditional Expression)

| | |
|---|---|
| (1) | 2.83 |
| (2) | 1.36 |
| (15) | 2.83 |
| (16) | 1.36 |

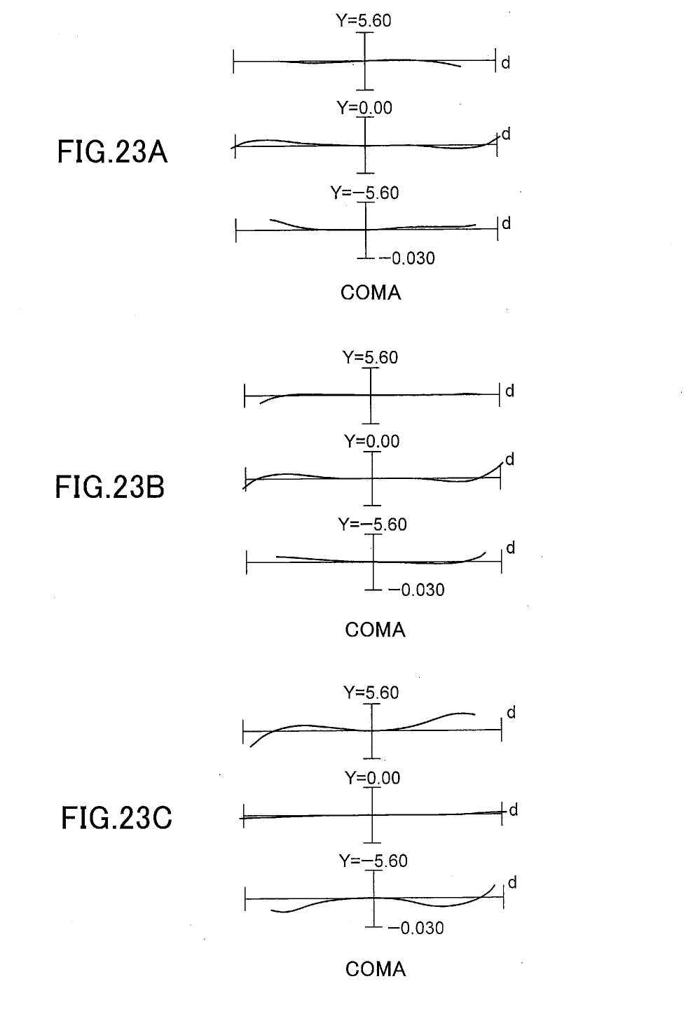

FIGS. 23A, 23B and 23C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making tilt decentering of the positive meniscus lens L4 of the first lens group G1 by means of the adjustment mechanism 30 and by performing a position adjustment for making tilt decentering of the lens group L7 of the second lens group G2 by means of the adjustment mechanism 30, and FIGS. 23A, 23B and 23C indicate the wide angle end state, the intermediate focal length state, and the telephoto end state, respectively.

As seen from the comparison of diagrams of coma aberrations shown in FIGS. 23A, 23B and 23C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 23A, 23B and 23C.

### Ninth Example

The adjustment mechanism of the variable focal length lens relating to the ninth Example of the present application is explained with reference to the accompanying drawings. In the ninth Example, so as to satisfactorily correct deterioration of an imaging performance owing to decentering error in the manufacture, there are provided an adjustment mechanism 30 to perform a position adjustment for making tilt decentering of the positive meniscus lens L4 on the most image side in the first lens group and an adjustment mechanism 50 to perform a position adjustment for making shift decentering of a vibration reduction lens group of the second lens group, for example, the lens group L8 positioned on the image side of the lens group L5.

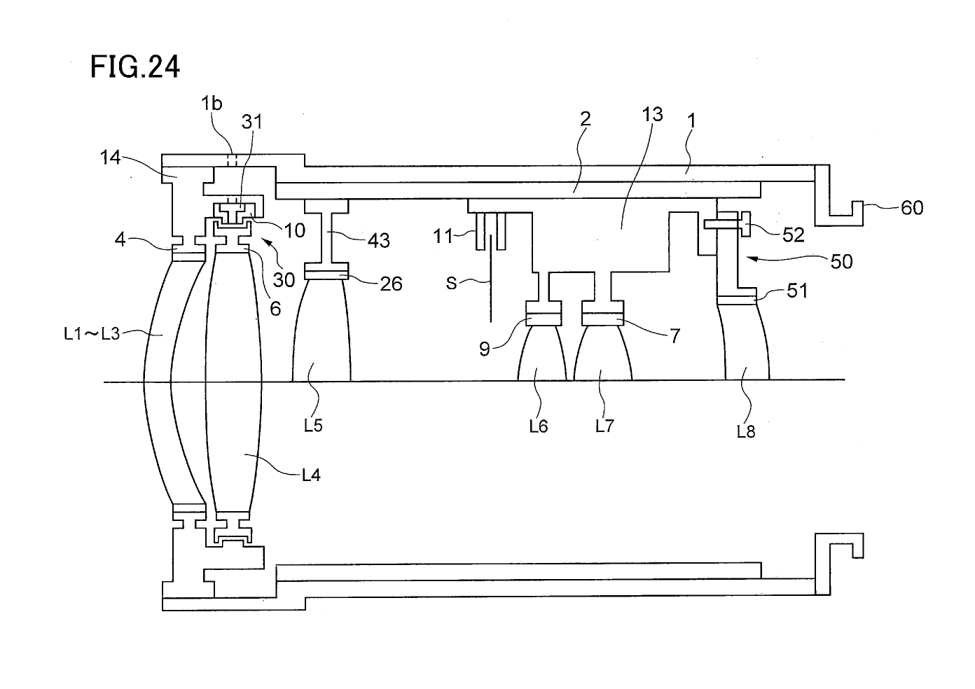

FIG. 24 is a view schematically showing a cross section of a configuration of the variable focal length lens relating to the ninth Example. In addition, portions having the same structures as those used in the third Example and the seventh Example are described using the same symbols, or the same symbols are shown on the drawings with the details omitted.

As shown in FIG. 24, a lens group L1-L3 of the first lens group G1 is held by a generally cylindrical holding member 4, the positive meniscus lens L4 of the first lens group G1 is held by a generally cylindrical holding member 6, the lens group L5 of the second lens group G2 is held by a generally cylindrical holding member 26, the iris stop S is held by a stop mechanism material 11, the lens group L6 of the second lens group G2 is held by a generally cylindrical holding member 9, the lens group L7 of the second lens group G2 is held by a generally cylindrical holding member 7, and the lens group L8 of the second lens group G2 is held by a generally cylindrical holding member 51.

The holding member 4 is fixed on an annular sliding member 14, the holding member 26 is held by a holding member 10 rotatably held in a recess 14a of the sliding member 14, and the sliding member 14 is movable on the optical axis by a fixed barrel 1. Further, the iris stop S is opened and closed by a stop mechanism 11.

The holding member 26 is held on a sliding member 43 slidably held on a cam barrel 2, and the holding members 7, 9 and the stop mechanism 11 are held on a sliding member 13 slidably held on the cam barrel 2. Further, the holding member 51 is fixed to the sliding member 13 slidably held on the cam barrel 2, by screws 52.

Cam pins (not shown) arranged in the sliding members 43, 13 are engaged with cam grooves (not shown) arranged in the cam barrel 2, whereby the sliding members 43, 13 are movable on the optical axis by the cam barrel 2 and the fixed barrel 1.

As shown in FIG. 24, the adjustment mechanism 30 in which the holding member 16 holding the positive meniscus lens L4 on the most image side in the first lens group G1 is fixed to the sliding member 14 and by which a position adjustment is made, is the same as that in the seventh Example (see FIGS. 6, 20), so that the details of configuration and operation of the adjustment mechanism are omitted. Additionally, it is possible to adjust a tilt of the holding member 4 with respect to the sliding member 14 and fix it, in the same manner as in the seventh Example. That is, in the variable focal length lens relating to the ninth Example of the present application, the adjustment mechanism 30 can perform a position adjustment for making tilt decentering of the positive meniscus lens L4 of the first lens group G1 to the optical axis.

Further, as shown in FIG. 24, the adjustment mechanism 50 in which the holding member 51 holding the lens group L8 of the second lens group G2 is fixed to the sliding member 13 and by which a position adjustment is made, is the same as that in the third Example (see FIGS. 10, 11), so that the details of configuration and operation of the adjustment mechanism are omitted. Additionally, it is possible to adjust a shift of the holding member 51 with respect to the sliding member 13 and fix it, in the same manner as in the third Example. That is, in the variable focal length lens relating to the ninth Example of the present application, the adjustment mechanism 50 can perform a position adjustment for making shift decentering of the lens group L8 of the second lens group G2 to the optical axis.

In this way, in the variable focal length lens of the present application, by the adjustment mechanism 30, it is possible to conduct a position adjustment for making tilt decentering of the positive meniscus lens L4 of the first lens group G1, and by the adjustment mechanism 50, it is possible to conduct a position adjustment for making shift decentering of the lens group L8 of the second lens group G2.

Table 10 below shows values corresponding to the respective conditional expressions (1), (2), (17) and (18) in the variable focal length lens relating to the seventh Example.

TABLE 10
(Values for Conditional Expression)

| | |
|---|---|
| (1) | 2.83 |
| (2) | 1.00 |
| (17) | 2.83 |
| (18) | 1.00 |

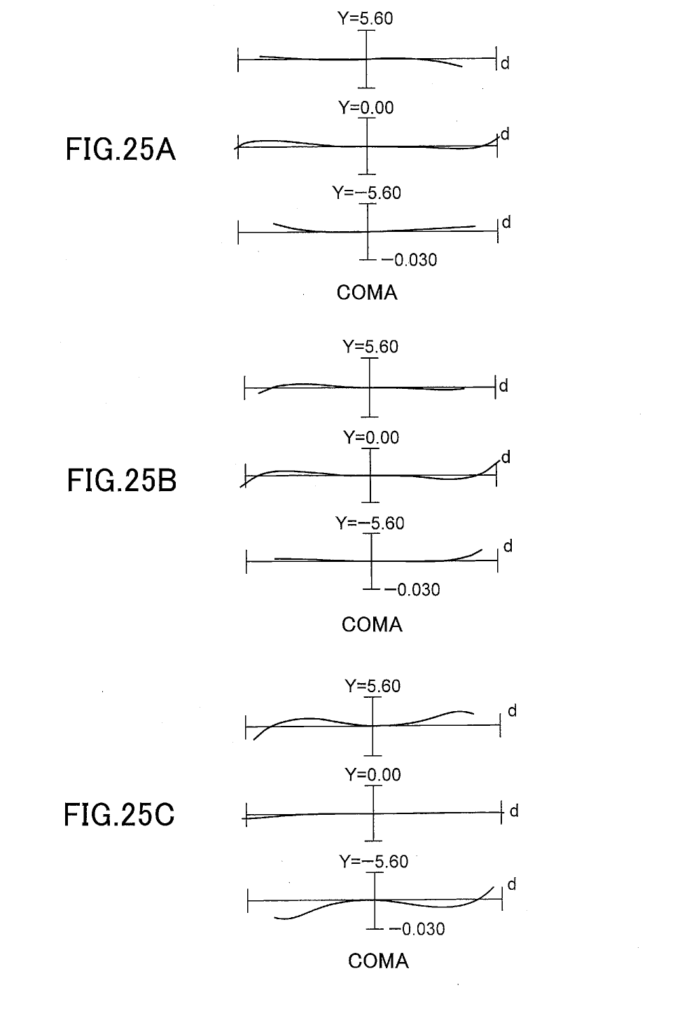

FIGS. 25A, 25B and 25C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making tilt decentering of the positive meniscus lens L4 of the first lens group G1 by means of the adjustment mechanism 30 and by performing a position adjustment for making shift decentering of the lens group L8 of the second lens group G2 by means of the adjustment mechanism 50, and FIGS. 25A, 25B and 25C indicate the wide angle end state, the intermediate focal length state, and the telephoto end state, respectively.

As seen from the comparison of diagrams of coma aberrations shown in FIGS. 25A, 25B and 25C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 25A, 25B and 25C.

### Tenth Example

The adjustment mechanism of the variable focal length lens relating to the tenth Example of the present application is explained with reference to the accompanying drawings. In the tenth Example, so as to satisfactorily correct deterioration of an imaging performance owing to decentering error in the manufacture, there are provided an adjustment mechanism 30 to perform a position adjustment for making tilt decentering of the positive meniscus lens L4 on the most image side in the first lens group G1 and an adjustment mechanism 55 to perform a position adjustment for making shift decentering of the positive meniscus lens L83 on the most image side in the second lens group G2.

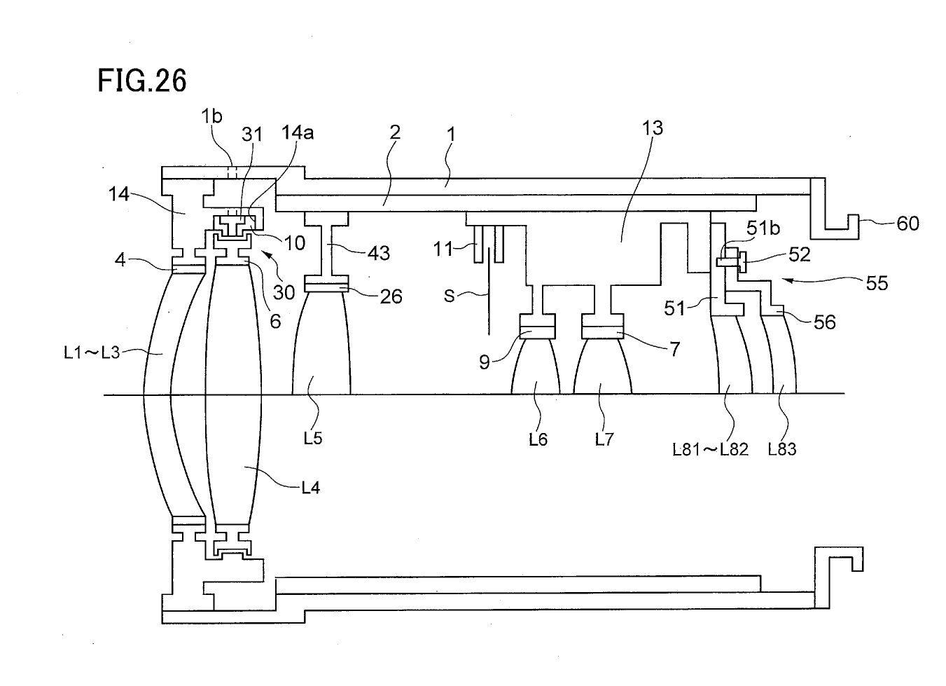

FIG. 26 is a view schematically showing a cross section of a configuration of the variable focal length lens relating to the tenth Example. In addition, portions having the same structures as those used in the seventh Example and the fourth Example are described using the same symbols, or the same symbols are shown on the drawings with the details omitted.

As shown in FIG. 26, a lens group L1-L3 of the first lens group G1 is held by a generally cylindrical holding member 4, the positive meniscus lens L4 of the first lens group G1 is held by a generally cylindrical holding member 6, the lens group L5 of the second lens group G2 is held by a generally cylindrical holding member 26, the iris stop S is held by a stop mechanism material 11, the lens group L7 of the second lens group G2 is held by a generally cylindrical holding member 7, a lens group L81, L82 as a part of the lens group L8 of the second lens group G2 is held by a generally cylindrical holding member 51, and the positive meniscus lens L83 on the most image side in the lens group L8 of the second lens group G2 is held by a generally cylindrical holding member 56.

The holding member 4 is fixed on an annular sliding member 14, the holding member 26 is held by a holding member 10 rotatably held in a recess 14a of the sliding member 14, and the sliding member 14 is movable on the optical axis by a fixed barrel 1. Further, the iris stop S is opened and closed by a stop mechanism 11.

The holding member 26 is held on a sliding member 43 slidably held on a cam barrel 2, the holding members 7, 9 and the stop mechanism 11 are held on a sliding member 13 slidably held on the cam barrel 2, and the holding member 51 is held on the sliding member 13 slidably held on the cam barrel 2. Further, the holding member 56 is fixed to the holding member 51 by screws 52.

Cam pins (not shown) arranged in the sliding members 43, 13 are engaged with cam grooves (not shown) arranged in the cam barrel 2, whereby the sliding members 43, 13 are movable on the optical axis by the cam barrel 2 and the fixed barrel 1.

On an image surface side of the fixed barrel 1, a mount member 60 is fixed by screws or the like (not shown), and the fixed barrel 1 is fixed onto a photographing apparatus such as a camera via the mount member 60.

As shown in FIG. 26, the adjustment mechanism. 30 in which the holding member 16 holding the positive meniscus lens L4 on the most image side in the first lens group G1 is fixed to the sliding member 14 and by which a position adjustment is made, is the same as that in the first Example as shown in FIG. 6, so that the details of configuration and operation of the adjustment mechanism are omitted. Additionally, it is possible to adjust a tilt of the holding member 4 with respect to the sliding member 14 and fix it, in the same manner as in the first Example. That is, in the variable focal length lens relating to the seventh Example of the present application, the adjustment mechanism 30 can perform a position adjustment for making tilt decentering of the positive meniscus lens L4 of the first lens group G1 to the optical axis.

Further, as shown in FIG. 26, the adjustment mechanism 55 in which the holding member 56 holding the positive meniscus lens L83 on the most image side in the second lens group G2 is fixed to the holding member 51 and by which a position adjustment is made, is the same as that in the fourth Example as shown in FIG. 14, so that the details of configuration and operation of the adjustment mechanism are omitted. Additionally, it is possible to adjust a shift of the holding member 56 with respect to the holding member 51 and fix it, in the same manner as in the fourth Example. That is, in the variable focal length lens relating to the tenth Example of the present application, it is possible to perform a position adjustment for making shift decentering of the positive meniscus lens L83 on the most image side in the second lens group G2 to the optical axis.

In this way, in the variable focal length lens of the present application, by the adjustment mechanism 30, it is possible to conduct a position adjustment for making tilt decentering of the positive meniscus lens L4 of the first lens group G1, and by the adjustment mechanism 55, it is possible to conduct a position adjustment for making shift decentering of the positive meniscus lens L83 on the most image side in the second lens group G2 to the optical axis.

Table 11 below shows values corresponding to the respective conditional expressions (1), (2) and (19) in the variable focal length lens relating to the tenth Example.

TABLE 11
(Values for Conditional Expression)

| | |
|---|---|
| (1) | 2.83 |
| (2) | 1.00 |
| (19) | 2.83 |

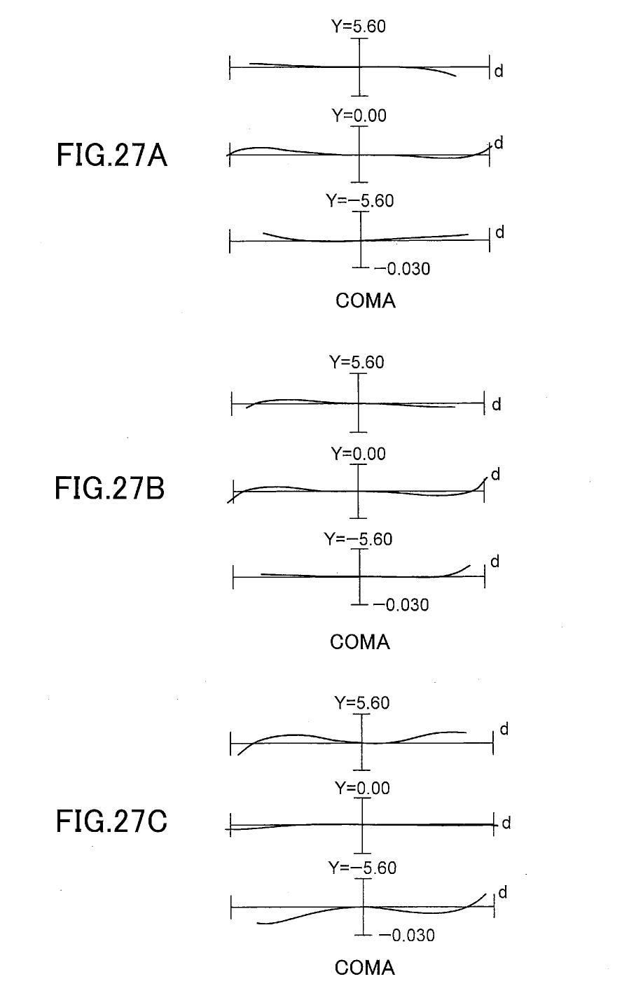

FIGS. 27A, 27B and 27C show diagrams of coma aberrations for d-line (wavelength λ=587.6 nm) in the infinite focusing state of the variable focal length lens relating to the first Example, when, in the case of occurrence of decentering error in the manufacture, decentering aberration is corrected by performing a position adjustment for making tilt decentering of the positive meniscus lens L4 of the first lens group G1 by means of the adjustment mechanism 30 and by performing a position adjustment for making shift decentering of the positive meniscus lens L83 on the most image side in the second lens group G2 by means of the adjustment mechanism 55, and FIGS. 27A, 27B and 27C indicate the wide angle end state, the intermediate focal length state, and the telephoto end state, respectively.

As seen from the comparison of diagrams of coma aberrations shown in FIGS. 27A, 27B and 27C with those shown in FIGS. 3A, 3B and 3C, deterioration of the coma aberration owing to decentering error in the manufacture is satisfactorily corrected to achieve a satisfactory imaging performance over the wide angle end state to the telephoto end state, in FIGS. 27A, 27B and 27C.

Next, a camera mounted with a variable focal length lens of the present application is described. Incidentally, while here is described a case where a variable focal length lens 1 relating to the first Example is mounted, a case where that of another Example is mounted is done in the same way.

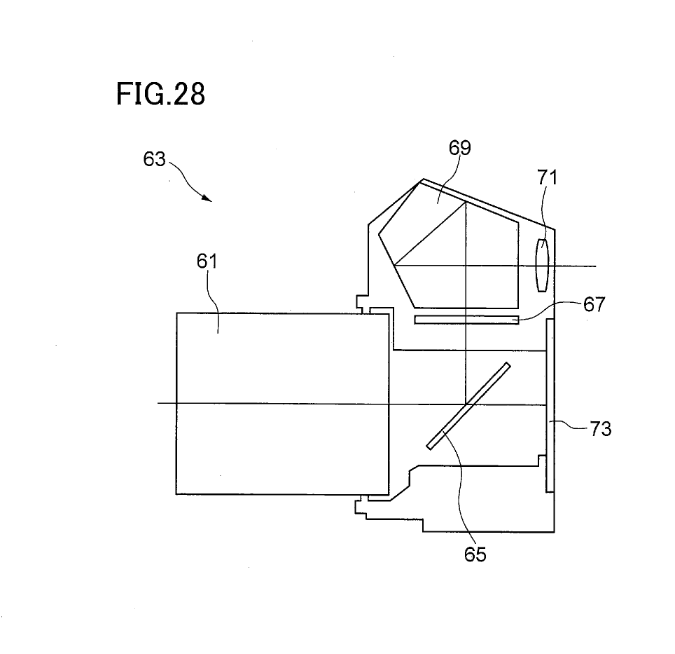

FIG. 28 is a view showing a configuration of a camera equipped with the variable focal length lens relating to the first Example.

In FIG. 28, the camera 63 is a digital single lens reflex-type camera equipped with the variable focal length lens 61 relating to the first Example. In the camera 63, light from an unillustrated subject, that is, an object is conversed by an imaging lens 61, and focused on a focusing screen 67 via a quick return mirror 65. Then, this light focused on the focusing screen 67 is reflected several times in a pentagonal prism 69 and guided to an eyepiece lens 71. Thereby, a photographer can monitor an object image as an erect image via the eyepiece lens 71.

Further, when the photographer presses an unillustrated release button, the quick return mirror is retreated to the outside of an optical path and the light from the object as unillustrated arrives at an imaging device 73. Accordingly, the light from the object is imaged by the imaging device 73 and recorded in an unillustrated memory as an object image. In this way, the photographer can take a photograph of the object by the camera 63.

By mounting the camera 63 with the variable focal length lens 1 relating to the first Example as an imaging lens, it is possible to realize a camera having a high performance.

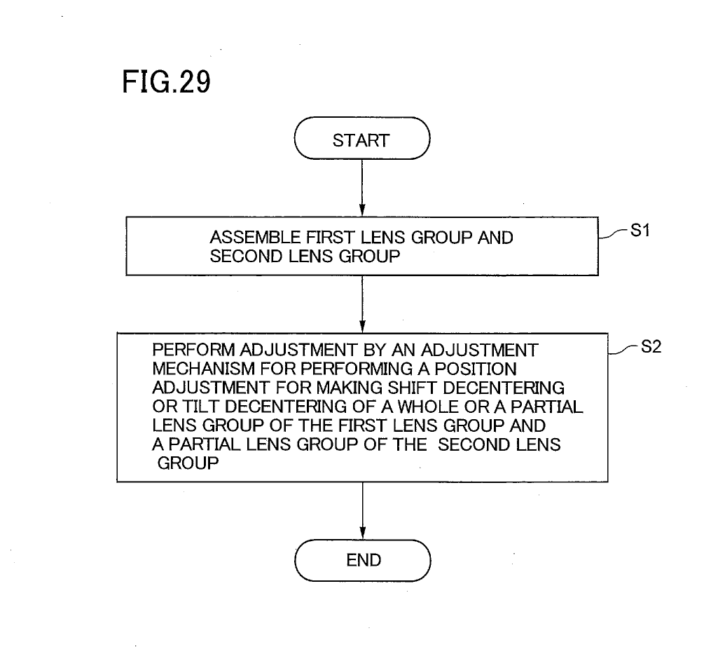

Next, an adjusting method of a variable focal length lens of the present application is explained. FIG. 29 is a flow chart showing schematically a method for adjusting the variable focal length lens of the present application.

A variable focal length lens adjusting method of the present application is an adjusting method for a variable focal length lens which comprises, in order from an object side, a first lens group having negative refractive power and a second lens group having positive refractive power, a focal length being varied by changing an air space between the first lens group and the second lens group, the method including the following steps S1 and S2 as shown in FIG. 29.

Step S1: assemble the first lens group and the second lens group, and

Step S2: perform adjustment by an adjustment mechanism for performing a position adjustment for making shift decentering or tilt decentering of a whole or a partial lens group of the first lens group and a partial lens group of the second lens group, after assembling the first lens group and the second lens group.

According to the above-mentioned method for adjusting the variable focal length lens, it is possible to provide a method of adjusting a variable focal length lens capable of achieving a satisfactory optical performance and reducing a cost.

In addition, while the above-mentioned description is made with constituent requirements of the embodiments so as to facilitate understanding of the present invention, the present invention is not limited to this.

What is claimed is:

1. A variable focal length lens comprising, in order from an object side, a first lens group having negative refractive power and a second lens group having positive refractive power;
a focal length being varied by changing an air space between the first lens group and the second lens group; and
an adjustment mechanism being provided, the adjustment mechanism performing a position adjustment for making shift decentering or tilt decentering of a whole or a partial lens group of the first lens group and a partial lens group of the second lens group, after assembling the first lens group and the second lens group.

2. A variable focal length lens according to claim 1, wherein the following conditional expressions are satisfied:
2.0<MAt/MAw
MBt/MBw<2.0
where MAt denotes a composite imaging magnification of a lens group positioned between the whole or the partial lens group of the first lens group subjected to the shift decentering or the tilt decentering and an image surface, in a telephoto end state of the variable focal length lens,
MAw denotes a composite imaging magnification of a lens group positioned between the whole or the partial lens group of the first lens group subjected to the shift decentering or the tilt decentering and the image surface, in a wide angle end state of the variable focal length lens,
MBt denotes a composite imaging magnification of a lens group positioned between the partial lens group of the second lens group subjected to the shift decentering or the tilt decentering and the image surface, in the telephoto end state of the variable focal length lens,
MBw denotes a composite imaging magnification of a lens group positioned between the partial lens group of the second lens group subjected to the shift decentering or the tilt decentering and the image surface, in the wide angle end state of the variable focal length lens, and
MBt=MBw=1 is set on condition that no lens group exists between the partial lens group of the second lens group and the image surface.

3. A variable focal length lens according to claim 1, wherein the second lens group comprises a vibration reduction lens group to be moved so as to include a component in a direction orthogonal to an optical axis.

4. A variable focal length lens according to claim 1, wherein
the first lens group comprises a positive lens on the most image side, and
the adjustment mechanism performs a position adjustment for making shift decentering of the positive lens and a position adjustment for making tilt decentering of a lens group on the most object side in the second lens group.

5. A variable focal length lens according to claim 4, wherein the following conditional expressions are satisfied:
2.0<MAt/MAw
MBt/MBw<−3.0
where MAt denotes a composite imaging magnification of a lens group positioned between the positive lens and an image surface, in a telephoto end state of the variable focal length lens,
MAw denotes a composite imaging magnification of the lens group positioned between the positive lens and the image surface, in a wide angle end state of the variable focal length lens,
MBt denotes a composite imaging magnification of a lens group positioned between the lens group on the most object side in the second lens group and the image surface, in the telephoto end state of the variable focal length lens, and
MBw denotes a composite imaging magnification of the lens group positioned between the lens group on the most object side in the second lens group and the image surface, in the wide angle end state of the variable focal length lens.

6. A variable focal length lens according to claim 1, wherein
a positive lens is provided on the most image side in the first lens group,
the second lens group comprises a vibration reduction lens group to be moved so as to include a component in a direction orthogonal to an optical axis,
the adjustment mechanism performs a position adjustment for making shift decentering of the positive lens and a position adjustment for making tilt decentering of the partial lens group of the second lens group, and
the vibration reduction lens group performs vibration reduction by making shift decentering of the partial lens group of the second lens group.

7. A variable focal length lens according to claim 6, wherein the following conditional expressions are satisfied:
2.0<MAt/MAw
MBt/MBw<2.0
where MAt denotes a composite imaging magnification of a lens group positioned between the positive lens and an image surface, in a telephoto end state of the variable focal length lens,
MAw denotes a composite imaging magnification of the lens group positioned between the positive lens and the image surface, in a wide angle end state of the variable focal length lens,
MBt denotes a composite imaging magnification of a lens group positioned between the vibration reduction lens group and the image surface, in the telephoto end state of the variable focal length lens,
MBw denotes a composite imaging magnification of the lens group positioned between the vibration reduction lens group and the image surface, in the wide angle end state of the variable focal length lens, and
MBt=MBw=1 is set on condition that no lens group exists between the vibration reduction lens group and the image surface.

8. A variable focal length lens according to claim 1, wherein
a positive lens is provided on the most image side in the first lens group,
the second lens group comprises a vibration reduction lens group to be moved so as to include a component in a direction orthogonal to an optical axis, and includes a negative lens group positioned on an image side of the vibration reduction lens group, and
the adjustment mechanism performs a position adjustment for making shift decentering of the positive lens and a position adjustment for making shift decentering of the negative lens group.

9. A variable focal length lens according to claim 8, wherein the following conditional expressions are satisfied:
2.0<MAt/MAw
MBt/MBw<2.0
where MAt denotes a composite imaging magnification of a lens group positioned between the positive lens and an image surface, in a telephoto end state of the variable focal length lens,
MAw denotes a composite imaging magnification of the lens group positioned between the positive lens and the image surface, in a wide angle end state of the variable focal length lens,
MBt denotes a composite imaging magnification of a lens group positioned between the negative lens group and the image surface, in the telephoto end state of the variable focal length lens,
MBw denotes a composite imaging magnification of the lens group positioned between the negative lens group and the image surface, in the wide angle end state of the variable focal length lens, and
MBt=MBw=1 is set on condition that no lens group exists between the negative lens group and the image surface.

10. A variable focal length lens according to claim 1, wherein
a positive lens is provided on the most image side in the first lens group and a positive lens is provided on the most image side in the second lens group, and
the adjustment mechanism performs a position adjustment for making shift decentering of the positive lens of the first lens group and a position adjustment for making shift decentering of the positive lens of the second lens group.

11. A variable focal length lens according to claim 10, wherein the following conditional expression is satisfied:
2.0<MAt/MAw
where MAt denotes a composite imaging magnification of a lens group positioned between the positive lens of the first lens group and an image surface, in a telephoto end state of the variable focal length lens, and
MAw denotes a composite imaging magnification of the lens group positioned between the positive lens of the first lens group and the image surface, in a wide angle end state of the variable focal length lens.

12. A variable focal length lens according to claim 1, wherein
the second lens group comprises a vibration reduction lens group to be moved so as to include a component in a direction orthogonal to an optical axis, and includes a negative lens group on an image side of the vibration reduction lens group, and
the adjustment mechanism performs a position adjustment for making tilt decentering of the whole first lens group and a position adjustment for making shift decentering of the negative lens group.

13. A variable focal length lens according to claim 12, wherein the following conditional expressions are satisfied:
2.0<MAt/MAw
MBt/MBw<2
where MAt denotes a composite imaging magnification of a lens group positioned between the first lens group and an image surface, in a telephoto end state of the variable focal length lens,
MAw denotes a composite imaging magnification of the lens group positioned between the first lens group and the image surface, in a wide angle end state of the variable focal length lens,
MBt denotes a composite imaging magnification of a lens group positioned between the negative lens group and the image surface, in the telephoto end state of the variable focal length lens,
MBw denotes a composite imaging magnification of the lens group positioned between the negative lens group and the image surface, in the wide angle end state of the variable focal length lens, and
MBt=MBw=1 is set on condition that no lens group exists between the negative lens group and the image surface.

14. A variable focal length lens according to claim 1, wherein
a positive lens is provided on the most image side in the second lens group, and
the adjustment mechanism performs a position adjustment for making tilt decentering of the whole first lens group and a position adjustment for making shift decentering of the positive lens.

15. A variable focal length lens according to claim 14, wherein the following conditional expression is satisfied:
2.0<MAt/MAw
where MAt denotes a composite imaging magnification of a lens group positioned between the first lens group and tan image surface, in a telephoto end state of the variable focal length lens, and
MAw denotes a composite imaging magnification of the lens group positioned between the first lens group and the image surface, in a wide angle end state of the variable focal length lens.

16. A variable focal length lens according to claim 1, wherein
a positive lens is provided on the most image side in the first lens group, and
the adjustment mechanism performs a position adjustment for making tilt decentering of the positive lens and a position adjustment for making tilt decentering a lens group on the most object side in the second lens group.

17. A variable focal length lens according to claim 16, wherein the following conditional expressions are satisfied:
2.0<MAt/MAw
MBt/MBw<−3.0
where MAt denotes a composite imaging magnification of a lens group positioned between the positive lens and an image surface, in a telephoto end state of the variable focal length lens,
MAw denotes a composite imaging magnification of the lens group positioned between the positive lens and the image surface, in a wide angle end state of the variable focal length lens,
MBt denotes a composite imaging magnification of a lens group positioned between the lens group on the most object side in the second lens group and the image surface, in the telephoto end state of the variable focal length lens, and
MBw denotes a composite imaging magnification of the lens group positioned between the lens group on the most object side in the second lens group and the image surface, in the wide angle end state of the variable focal length lens.

18. A variable focal length lens according to claim 1, wherein
a positive lens is provided on the most image side in the first lens group,
the second lens group comprises a vibration reduction lens group to be moved so as to include a component in a direction orthogonal to an optical axis,
the adjustment mechanism performs a position adjustment for making tilt decentering of the positive lens and a position adjustment for making tilt decentering of the partial lens group of the second lens group, and
the vibration reduction lens group performs vibration reduction by making shift decentering of the partial lens group.

19. A variable focal length lens according to claim 18, wherein the following conditional expressions are satisfied:
2.0<MAt/MAw
MBt/MBw<2.0
where MAt denotes a composite imaging magnification of a lens group positioned between the positive lens and an image surface, in a telephoto end state of the variable focal length lens,
MAw denotes a composite imaging magnification of the lens group positioned between the positive lens and the image surface, in a wide angle end state of the variable focal length lens,
MBt denotes a composite imaging magnification of a lens group positioned between the vibration reduction lens group and the image surface, in the telephoto end state of the variable focal length lens,
MBw denotes a composite imaging magnification of the lens group positioned between the vibration reduction lens group and the image surface, in the wide angle end state of the variable focal length lens, and
MBt=MBw=1 is set on condition that no lens group exists between the vibration reduction lens group and the image surface.

20. A variable focal length lens according to claim 1, wherein
a positive lens is provided on the most image side in the first lens group,
the second lens group comprises a vibration reduction lens group to be moved so as to include a component in a direction orthogonal to an optical axis, and includes a negative lens group positioned on an image side of the vibration reduction lens group, and
the adjustment mechanism performs a position adjustment for making tilt decentering of the positive lens and a position adjustment for making shift decentering of the negative lens group.

21. A variable focal length lens according to claim 20, wherein the following conditional expressions are satisfied:
2.0<MAt/MAw
MBt/MBw<2
where MAt denotes a composite imaging magnification of a lens group positioned between the positive lens and an image surface, in a telephoto end state of the variable focal length lens,
MAw denotes a composite imaging magnification of the lens group positioned between the positive lens and the image surface, in a wide angle end state of the variable focal length lens,
MBt denotes a composite imaging magnification of a lens group positioned between the negative lens group and the image surface, in the telephoto end state of the variable focal length lens,
MBw denotes a composite imaging magnification of the lens group positioned between the negative lens group and the image surface, in the wide angle end state of the variable focal length lens, and
MBt=MBw=1 is set on condition that no lens group exists between the negative lens group and the image surface.

22. A variable focal length lens according to claim 1, wherein
a positive lens is provided on the most image side in the first lens group and a positive lens is provided on the most image side in the second lens group, and
the adjustment mechanism performs a position adjustment for making tilt decentering of the positive lens of the first lens group and a position adjustment for making shift decentering of the positive lens of the second lens group.

23. A variable focal length lens according to claim 22 wherein the following conditional expression is satisfied:
2.0<MAt/MAw
where MAt denotes a composite imaging magnification of a lens group positioned between the positive lens of the first lens group and an image surface, in a telephoto end state of the variable focal length lens, and
MAw denotes a composite imaging magnification of the lens group positioned between the positive lens of the first lens group and the image surface, in a wide angle end state of the variable focal length lens.

24. A variable focal length lens according to claim 1, wherein
an iris stop is provided, and
the iris stop is moved integrally with the second lens group when the focal length is varied.

25. A variable focal length lens according to claim 1, wherein
a positive lens is provided on the most image side, and
the adjustment mechanism performs a position adjustment for making shift decentering of the positive lens.

26. A variable focal length lens according to claim 1, wherein
the second lens group comprises a vibration reduction lens group to be moved so as to include a component in a direction orthogonal to an optical axis, and includes a negative lens group on an image side of the vibration reduction lens group, and
the adjustment mechanism performs a position adjustment for making tilt decentering of the whole first lens group.

27. A variable focal length lens according to claim 1, wherein
a positive lens is provided on the most image side in the first lens group, and
the adjustment mechanism performs a position adjustment for making tilt decentering of the positive lens.

28. A variable focal length lens according to claim 1, wherein the adjustment mechanism performs a position adjustment for making tilt decentering of a lens group on the most object side in the second lens group.

29. A variable focal length lens according to claim 1, wherein
the second lens group comprises a vibration reduction lens group to be moved so as to include a component in a direction orthogonal to an optical axis,
the adjustment mechanism performs a position adjustment for making tilt decentering of the partial lens group of the second lens group, and
the vibration reduction lens group performs vibration reduction by making shift decentering of the partial lens group of the second lens group.

30. A variable focal length lens according to claim 1, wherein
the second lens group comprises a vibration reduction lens group to be moved so as to include a component in a direction orthogonal to an optical axis, and includes a negative lens group positioned on an image side of the vibration reduction lens group, and
the adjustment mechanism performs a position adjustment for making shift decentering of the negative lens group.

31. A variable focal length lens according to claim 1, wherein
a positive lens is provided on the most image side in the second lens group, and
the adjustment mechanism performs a position adjustment for making shift decentering of the positive lens.

32. An optical apparatus equipped with a variable focal length lens according to claim 1.

33. A method for adjusting a variable focal length lens which comprises, in order from an object side, a first lens group having negative refractive power and a second lens group having positive refractive power,
a focal length being varied by changing an air space between the first lens group and the second lens group;
the adjustment in the method being performed by an adjustment mechanism for performing a position adjustment for making shift decentering or tilt decentering of a whole or a partial lens group of the first lens group and a partial lens group of the second lens group, after assembling the first lens group and the second lens group.

34. A method for adjusting a variable focal length lens, according to claim 33, wherein
the first lens group comprises a positive lens on the most image side, and
the adjustment mechanism performs a position adjustment for making shift decentering of the positive lens.

35. A method for adjusting a variable focal length lens, according to claim 33, wherein
the second lens group comprises a vibration reduction lens group to be moved so as to include a component in a direction orthogonal to an optical axis, and includes a negative lens group on an image side of the vibration reduction lens group, and
the adjustment mechanism performs a position adjustment for making tilt decentering of the whole first lens group.

36. A method for adjusting a variable focal length lens, according to claim 33, wherein
a positive lens is provided on the most image side in the first lens group, and
the adjustment mechanism performs a position adjustment for making tilt decentering of the positive lens.

37. A method for adjusting a variable focal length lens according to claim 33, wherein the adjustment mechanism performs a position adjustment for making tilt decentering of a lens group on the most object side in the second lens group.

38. A method for adjusting a variable focal length lens, according to claim 33, wherein
the second lens group comprises a vibration reduction lens group to be moved so as to include a component in a direction orthogonal to an optical axis,
the adjustment mechanism performs a position adjustment for making tilt decentering of the partial lens group of the second lens group, and
the vibration reduction lens group performs vibration reduction by making shift decentering of the partial lens group of the second lens group.

39. A method for adjusting a variable focal length lens, according to claim 33, wherein
the second lens group comprises a vibration reduction lens group to be moved so as to include a component in a direction orthogonal to an optical axis, and includes a negative lens group positioned on an image side of the vibration reduction lens group, and
the adjustment mechanism performs a position adjustment for making shift decentering of the negative lens group.

40. A method for adjusting a variable focal length lens, according to claim 33, wherein
a positive lens is provided on the most image side in the second lens group, and
the adjustment mechanism performs a position adjustment for making shift decentering of the positive lens.
